(19) United States
(12) Patent Application Publication
(10) Pub. No.: US 2022/0354302 A1
(43) Pub. Date: Nov. 10, 2022

(54) Air Fryer and Control Method and Stepless Speed Control Method therefor

(71) Applicant: Shenzhen Hesung Innovation Technology Co., Ltd., Shenzhen (CN)

(72) Inventors: AiMin HE, Shenzhen (CN); XiangHe ZHANG, Shenzhen (CN)

(21) Appl. No.: 17/546,036

(22) Filed: Dec. 8, 2021

(30) Foreign Application Priority Data
May 7, 2021 (CN) 202110496395.9

(51) Int. Cl. A47J 37/06

(52) U.S. Cl. CPC A47J 37/0641; A47J 37/0664

(57) ABSTRACT

An air fryer includes an air frying chamber for receiving a food therein, an air circulation device and an air heater. A control method for the air fryer includes the steps of controlling an air flow to be circulated in the air frying chamber of the air fryer via a control of the air circulation device, controlling an air temperature in the air frying chamber via a control of the air heater, and selectively controlling an air flow rate of the air in the air frying chamber according to a texture of the food, wherein the air flow rate is selected to match with the texture of the food to be air-fried.

### CROSS REFERENCE OF RELATED APPLICATION

This is a non-provisional application that claims the benefit of priority under 35 U.S.C. § 119 to a Chinese application, application number 202110496395.9, filed May 7, 2021, which is incorporated herewith by reference in its entirety.

### BACKGROUND OF THE PRESENT INVENTION

### Field of Invention

The present invention relates to air fryer, and more particularly to an air fryer and a controlling and stepless speed control method for air fryer.

### Description of Related Arts

An air fryer is a machine that uses hot air for frying, which is a kitchen appliance that cooks food, such as French fries, vegetables or meat, by circulating hot air instead of frying the food by boiling oils in a cooking pan. Through the circulating hot air in a food basket of the air fryer, moisture on the food surface will be removed to brown the food so as to achieve the conventional frying effect. Since the air fryer is able to not only reduce the amount of fat in the food but also keep the frying qualities of the food, such as the appearance and taste of the fried food. Therefore, the air fryers are so popular and have great commercial values.

The current air fryer generally comprises a housing, an electric heat and a fan disposed in the housing, a basket placed in the housing, and a controller that controls operations of the electric heater and the fan. When a food is placed in the basket, the controller is activated to power on the electric heater for heating up the air in the housing to form hot air, wherein the controller is also activated to power on the fan for blowing hot air and encircling the hot air in the basket so as to air-fry the food therein.

For the operation of the existing air fryer, when the existing air fryer is powered on initially, the controller will be firstly activated to control the electric heater for start heating up the air in the housing. At the same time, when the air temperature in the housing reaches an upper limit of a preset temperature, the controller will stop the operation of the electric heater to prevent the overheating in the housing. Meanwhile, a portion of heat in the housing will be absorbed by the food during air-frying process while another portion of heat will be rapidly lost by the rotational force of the fan. In other words, the air temperature in the housing will drop rapidly. Then, once the air temperature in the housing reaches a lower limit of the preset temperature, the controller will re-start the operation of the electric heater to generate heat again in the housing. Such temperature control will be repeated via the operation of the controller to fluctuate the air temperature in the housing close to the preset temperature. Finally, when operating the existing air fryer for a period of cooking time, the controller will stop the operations of the electric heater and the fan so as to end the air-frying process.

However, no matter the operation of the electric heater is switched on or off, the fan will run at the same full speed during the entire air-frying process, such that the existing air fryer requires relatively long heating time to heat the air in the housing after it is switched on. In other words, the existing air fryer has poor air frying efficiency, poor cooking quality, and poor air-frying result for the food. Meanwhile, the air temperature in the housing will be dropped rapidly due to the full speed of the fan after the air in the housing is heated at a temperature close to the preset temperature. Therefore, the electric heater must be frequently switched on to re-heat the air in the housing. In other words, it is a waste of heat energy generated by the electric heater to compensate the heat loss from the fan, while the vast air temperature fluctuation in the housing will affect the air-frying process to cook the food, such as the appearance and the taste of the food.

Furthermore, since different foods, such as French fries, chickens, steaks, port chops, fishes and shrimps, and etc., have different textures, water contents and fat contents, the amount of dehydration and fat reduction required in the air-frying process are also different. Accordingly, the air flow rate of the fan in the housing is one of the main factors to determine the dehydration and fat reduction speed of the food. Therefore, when the existing air fryer is arranged to cook or air-fry different foods, the food with less water content or fat content will become harder and dryer due to excessive dehydration or fat reduction. On the other hand, food with more water content or fat content will become softer and moist due to the low dehydration or fat reduction. In other words, the existing air fryer cannot provide good air-frying ability especially different tastes and air-frying qualities under the same setting of the existing air fryer.

### SUMMARY OF THE PRESENT INVENTION

The invention is advantageous in that it provides an air fryer and a control method and a stepless speed control method therefor, wherein the air flow rate in the air fryer is able to be selectively regulated so as to improve the air frying ability of the air fryer.

Another advantage of the invention is to provide a control method and a stepless speed control method for an air fryer, wherein the control method is configured to selectively adjust the air flow in the air fryer according to the texture or material of the food so as to optimize the dehydration and fat reduction process for air-frying the food.

Another advantage of the invention is to provide a control method and a stepless speed control method for an air fryer, wherein the control method is configured to selectively adjust different air flow rates according to different textures of the foods to match with different dehydration and fat reduction processes for air-frying different textures of the foods, so as to improve the frying qualities of the food, such as the appearance and taste of the fried food.

Another advantage of the invention is to provide a control method and a stepless speed control method for an air fryer, wherein the control method is configured to adjust the air flow rate in the air fryer according to different stages of the air frying process, so as to control the air temperature in the air fryer for improving the air frying ability.

Another advantage of the invention is to provide a control method and a stepless speed control method for an air fryer, wherein the stepless speed control method is configured to control the driving power of the air circulation device of the air fryer through pulse waves, so as to control the air flow rate in the air fryer in a stepless manner.

Another advantage of the invention is to provide a control method and a stepless speed control method for an air fryer, wherein the stepless speed control method is configured to frequently switch between a high-speed operating state and a low-speed operating state of the fan in response to the high level and low level of the pulse waves, so as to accurately control the driving power of the fan of the air circulation device.

Another advantage of the invention is to provide a control method and a stepless speed control method for an air fryer, wherein the stepless speed control method is configured to continuously adjust the driving power of the air circulation device in a real time manner by modulating the duty ratio of the pulse wave, so as to adjust the air flow rate in the air fryer in a stepless manner.

Another advantage of the invention is to provide a control method and a stepless speed control method for an air fryer, wherein the stepless speed control method is configured to regulate the frequency of the power supply by modulating the frequency of the pulse wave, so as to continuously adjust the rotation speed of the fan, such that the stepless speed control is applied to the fan.

Another advantage of the invention is to provide a control method and a stepless speed control method for an air fryer, wherein the air fryer provides a dry and low temperature environment for the operation of the electric motor so as to prolong the service life span of the fan.

Another advantage of the invention is to provide a control method and a stepless speed control method for an air fryer, wherein no complicated structure or algorithms is used in the present invention in order to achieve the above mentioned objects. Therefore, the present invention successfully provides an economic and efficient solution not only for providing a simple control method and stepless speed control method for controlling the operation of the air fryer but also enhancing the practical use and reliability of the air fryer.

According to the present invention, the foregoing and other objects and advantages are attained by a control method for an air fryer which has an air frying chamber for receiving a food therein and comprises an air circulation device and an air heater, comprising the steps of:

controlling an air flow to be circulated in the air frying chamber of the air fryer via a control of the air circulation device;

controlling an air temperature in the air frying chamber via a control of the air heater; and

selectively controlling an air flow rate of the air in the air frying chamber according to a texture of the food, wherein the air flow rate is selected to match with the texture of the food to be air-fried.

In one embodiment, an operating threshold of a driving power of the air circulation device is selectively adjusted according to a moisture content and/or fat content of the food as the texture thereof, such that a maximum air flow rate in the air frying chamber is direct proportion to the moisture content and/or the fat content of the food for being air-fried.

In one embodiment, the air flow rate in the air frying chamber is selectively controlled according to the texture of the food in the air frying chamber, wherein the step of matching the air flow rate with the food further comprises the steps of:

identifying the texture of the food to generate a food texture parameter;

selecting a preset threshold command from a command list in response to the food texture parameter; and

in response to the preset threshold command, selectively adjusting the operating threshold of the driving power of the air circulation device so as to selectively adjust the air flow rate in the air frying chamber in a real time manner not higher than the maximum air flow rate.

In one embodiment, the operating threshold of the driving power of the air circulation device is adjusted by modulating a parameter of a stepless control signal within a parameter modulation range.

In one embodiment, the control method further comprises a step of:

according to the working stages of the air fryer, controlling the air flow rate in the air frying chamber by a stepless speed control method, wherein the stepless speed control method comprises the steps:

according to the working stages of the air fryer, modulating the parameters of the stepless control signal; and

in response to the stepless control signal after being modulated, adjust the driving power of the air circulation device of the air fryer in a stepless manner to control the air flow rate in the air frying chamber.

In one embodiment, the control method further comprises a step of:

according to the texture of the food in the air frying chamber, selectively adjusting the maximum air temperature in the air frying chamber to match the air maximum temperature with the food to be air-fried.

In accordance with another aspect of the invention, the present invention comprises a stepless speed control method for an air fryer which has an air frying chamber for receiving a food therein and comprises an air circulation device and an air heater, comprising the steps of:

S100: modulating a parameter of a stepless control signal according to different working stages of the air fryer; and

S200: in response to the stepless control signal after being modulated, adjusting a driving power of the air circulation device of the air fryer in a stepless manner to control an air flow rate in the air frying chamber.

In one embodiment, the stepless control signal is a pulse wave, and the parameter of the stepless control signal includes a duty ratio of the pulse wave.

In one embodiment, the step (S200) further comprises the steps of:

in response to a high electric level of the pulse wave, controllably powering on a power supply circuit of the air circulation device in a real time manner via a switching unit, wherein the current working voltage of a fan is equal to a real-time voltage applied to the fan through the power supply circuit, such that the fan is operated in a high speed operation stage; and

in response to a low electric level of the pulse wave, controllably powering off the power supply circuit of the air circulation device in a real time manner via the switching unit, wherein the current working voltage of the fan is equal to zero, such that the fan is operated in a low speed operation stage.

In one embodiment, the step (S100) further comprises the steps of:

when the air fryer is operated in a preheating stage, adjusting the duty ratio of the pulse wave to zero, such that the driving power of the air circulation device is adjusted to be zero power;

when the air fryer is operated in a primary heating stage, adjustably increasing the duty ratio of the pulse wave is set as zero, such that the driving power of the air circulation device is adjusted in a stepless manner;

when the air fryer is operated in a constant temperature heating stage, modulating the duty ratio of the pulse wave to adjust the driving power of the air circulation device in a stepless manner; and

when the air fryer is operated in the cooling stage, adjusting the duty ratio of the pulse wave to 1, such that the driving power of the air circulation device is adjusted at its full power.

In one embodiment, when the air fryer is operated in a primary heating stage, the duty ratio of the pulse wave is increased, wherein the step of increasing the driving power of the air circulation device in a stepless manner further comprises the steps of:

when the air fryer is operated in the rapid heating stage, adjusting the duty ratio of the pulse wave to a preset low threshold, such that the driving power of the air circulation device is adjusted to a low power; and

when the air fryer is operated in the uniform heating stage, adjusting the duty ratio of the pulse wave to 1, such that the driving power of the air circulation device is adjusted to full power.

In one embodiment, the step of modulating the duty ratio of the pulse wave when the air fryer being in the constant temperature heating stage to adjust the driving power of the air circulation device in a stepless manner further comprises the steps of:

when the air fryer is operated in the constant temperature heating stage, adjusting the duty cycle of the pulse wave to a preset high threshold so as to adjust the driving power of the air circulation device to a high power, such that the heat dissipation power of the air fryer is equal to the heating power of the air heater of the air fryer.

In one embodiment, the step of modulating the duty ratio of the pulse wave when the air fryer is operated in a constant temperature heating stage to adjust the driving power of the air circulation device in a stepless manner further comprises the step of:

when the air fryer is operated in the constant temperature heating stage, detecting and analyzing the air temperature in the air frying chamber of the air fryer in a real time manner to detect an air temperature change in the air frying chamber;

when a current air temperature increase above a first temperature threshold between an upper limit and a lower limit of a preset target temperature, increasing the duty ratio of the pulse wave to adjustably increase the driving power of the air circulation device in a stepless manner; and

when the current air temperature drops below a second temperature threshold between the upper limit and the lower limit of the preset target temperature, decreasing the duty ratio of the pulse wave to adjustably reduce the driving power of the air circulation device in a stepless manner, so as to maintain the air temperature in the air frying chamber between the upper and lower limits of the preset target temperature.

In one embodiment, the stepless control signal is a pulse wave, and the parameter of the stepless control signal includes the frequency of the pulse wave.

In one embodiment, the step (S200) further comprises a step of:

in response to the frequency of the pulse wave, adjusting the frequency of the power supplied to the fan from the power supply circuit in a real time manner by the frequency converter, so as to controllably adjust the rotational speed of the fan in a stepless manner, such that the driving power of the air circulation device is adjusted in a stepless manner.

In one embodiment, the step (S100) further comprises the steps of:

when the air fryer is operated in the preheating stage, adjusting the frequency of the pulse wave to 0 Hz, such that the fan of the air circulation device stops rotating;

when the air fryer is operated in the primary heating stage, adjustably increasing the frequency of the pulse wave, such that the rotational speed of the fan of the air circulation device is adjusted in a stepless manner;

when the air fryer is operated in the constant temperature heating stage, modulating the frequency of the pulse wave to adjust the rotational speed of the fan of the air circulation device in a stepless manner; and

when the air fryer is operated in the cooling stage, controllably adjusting the frequency of the pulse wave to a rated frequency, such that the rotational speed of the fan of the air circulation device is adjusted to the full speed.

In one embodiment, the step of modulating the frequency of the pulse wave when the air fryer is operated in a constant temperature heating stage to adjust the rotational speed of the fan in a stepless manner further comprises the steps of:

when the air fryer is operated in the constant temperature heating stage, detecting and analyzing the air temperature in the air frying chamber of the air fryer in a real time manner to detect an air temperature change in the air frying chamber;

when the current air temperature increases above the first temperature threshold between the upper limit and the lower limit of the preset target temperature, increasing the frequency of the pulse wave, such that the rotation speed of the fan of the air circulation device is adjusted in a stepless manner; and

when the current air temperature drops below to the second temperature threshold between the upper limit and the lower limit of the preset target temperature, reducing the frequency of the pulse wave, such that the rotational speed of the fan of the air circulation device adjusted in a stepless manner to maintain the air temperature in the air frying chamber between the upper limit and the lower limit of the preset target temperature.

In accordance with another aspect of the invention, the present invention comprises a stepless speed control system for an air fryer which has an air frying chamber for receiving a food therein and comprises an air circulation device and an air heater, wherein the stepless speed control system comprises:

a signal modulation module that modulates a parameter of a stepless control signal according to a working stage of the air fryer; and

a power adjustment module that adjusts a driving power of the air circulation device in a stepless manner in response to the stepless control signal after being modulated, so as to control an air flow rate in the air frying chamber.

In one embodiment, the stepless control signal is a pulse wave, and the parameter of the stepless control signal includes a duty ratio of the pulse wave.

In one embodiment, the power adjustment module is further configured to: in response to a high electric level of the pulse wave, controllably power on a power supply circuit of the air circulation device in a real time manner via a switching unit, wherein a current working voltage of the fan is equal to the real-time voltage applied to the fan through the power supply circuit, such that the fan is operated in a high speed operation stage; and in response to a low electric level of the pulse wave, controllably power off the power supply circuit of the air circulation device in a real time manner via the switching unit, wherein the current working voltage of the fan is equal to zero, such that the fan is operated in a low speed operation stage.

In one embodiment, the signal modulation module further comprises a duty ratio adjustment module configured to: when the air fryer is operated in the preheating stage, adjust the duty ratio of the pulse wave to zero, such that the driving power of the air circulation device is adjusted to be zero power; when the air fryer is operated in the primary heating stage, adjustably increase the duty ratio of the pulse wave is set as zero, such that the driving power of the air circulation device is adjusted in a stepless manner; when the air fryer is operated in the constant temperature heating stage, modulate the duty ratio of the pulse wave to adjust the driving power of the air circulation device in a stepless manner; and when the air fryer is operated in the cooling stage, adjust the duty ratio of the pulse wave to 1, such that the driving power of the air circulation device can be adjusted at its full power.

In one embodiment, the signal modulation module further comprises a temperature analysis module operatively connected to the duty ratio adjustment module, wherein the temperature analysis module is configured to detect and analyze the air temperature in the air frying chamber of the air fryer in a real time manner when the air fryer in the constant temperature heating stage, so as to detect an air temperature change in the air frying chamber, wherein the duty ratio adjustment module is further configured to increase the duty ratio of the pulse wave when he current air temperature of the air increase above a first temperature threshold between the upper limit and the lower limit of the preset target temperature, so as to adjustably increase the driving power of the air circulation device in a stepless manner; and decrease the duty ratio of the pulse wave to adjustably reduce the driving power of the air circulation device in a stepless manner when the current air temperature of the air drops below a second temperature threshold between the upper limit and the lower limit of the preset target temperature, so as to maintain the air temperature in the air frying chamber between the upper and lower limits of the preset target temperature.

In one embodiment, the stepless control signal is a pulse wave, and the parameter of the stepless control signal includes the frequency of the pulse wave.

In one embodiment, the power adjustment module is further configured to: in response to the frequency of the pulse wave, adjust the frequency of the power supplied to the fan via the power supply circuit in a real time manner by the frequency converter for adjusting the rotational speed of the fan in a real time manner so as to adjust the driving power of the air circulation device in a stepless manner.

In one embodiment, the signal modulation module further comprises a frequency adjustment module configured to: when the air fryer is operated in the preheating stage, adjust the frequency of the pulse wave to 0 Hz, such that the fan of the air circulation device stops rotating; when the air fryer is operated in the primary heating stage, adjustably increase the frequency of the pulse wave, such that the rotational speed of the fan of the air circulation device is adjusted in a stepless manner; when the air fryer is operated in the constant temperature heating stage, modulate the frequency of the pulse wave to adjust the rotational speed of the fan of the air circulation device in a stepless manner; and when the air fryer is operated in the cooling stage, controllably adjust the frequency of the pulse wave to a rated frequency, such that the rotational speed of the fan of the air circulation device is adjusted to the full speed.

In one embodiment, the signal modulation module further a temperature analysis module configured to detect and analyze the air temperature in the air frying chamber of the air fryer in a real time manner when the air fryer is operated in the constant temperature heating stage, so as to detect the air temperature change in the air frying chamber, wherein the frequency adjustment module is configured to: when the current air temperature increases above the first temperature threshold between the upper limit and the lower limit of the preset target temperature, increase the frequency of the pulse wave, such that the rotation speed of the fan of the air circulation device is adjusted in a stepless manner; and when the current air temperature drops below to the second temperature threshold between the upper limit and the lower limit of the preset target temperature, reduce the frequency of the pulse wave, such that the rotational speed of the fan of the air circulation device adjusted in a stepless manner to maintain the air temperature in the air frying chamber between the upper limit and the lower limit of the preset target temperature.

In accordance with another aspect of the invention, the present invention comprises an electronic device for an air fryer, comprising:

a processor for executing program instructions; and

a memory that stores the program instructions being executed by the processor to implement a stepless speed control method, wherein the stepless speed control method comprises the steps:

S100: according to the working stage of an air fryer, modulating a parameter of a stepless control signal; and

S200: in response to the stepless control signal after being modulated, adjusting the driving power of an air circulation device of the air fryer in a stepless manner to control an air flow rate in an air frying chamber of the air fryer.

In accordance with another aspect of the invention, the present invention comprises a control system for an air fryer which has an air frying chamber for receiving a food therein and comprises an air circulation device and an air heater, comprising:

a driver control module configured to control the air circulation device of the air fryer to drive the air circulating in an air frying chamber of the air fryer;

a heat control module configured to control the air heater of the air fryer to heat the air in the air frying chamber; and

a flow rate control module configured to selectively adjust the air flow rate in the air frying chamber according to the texture of the food to be air-fried in the air frying chamber, so as to match the air flow rate with the texture of the food.

In one embodiment, the flow rate control module comprises a material recognition module, a command instruction module, and a threshold control module operatively connected with each other, wherein the material identification module is configured to identify the material or texture of the food to be air-fried to obtain a material identification result, wherein the command instruction module is configured to select the preset threshold command from the command list in response to the material recognition result, wherein the threshold control module is configured to adjust the operating threshold of the driving power of the air circulation device to be equal to a predetermined threshold in response to the preset threshold instruction, such that the air flow rate in the air frying chamber is adjusted in a real time manner not higher than the maximum air flow rate.

In one embodiment, the control system further comprises a temperature control module configured to selectively adjust the maximum air temperature in the air frying chamber according to the texture of the food therein, so as to match the maximum air temperature with the food for being air-fried.

In accordance with another aspect of the invention, the present invention comprises an electronic device for an air fryer, comprising:

a processor for executing program instructions; and

a memory that stores the program instructions being executed by the processor to implement a control method, wherein the control method comprises the steps:

controlling an air flow to be circulated in the air frying chamber of the air fryer via the control of the air circulation device;

controlling an air temperature in the air frying chamber via the control of the air heater; and

selectively controlling an air flow rate of the air in the air frying chamber according to the texture of the food, wherein the air flow rate is selected to match with the texture of the food to be air-fried.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a flow chart illustrating a control method for an air fryer according to a preferred embodiment of the present invention.

FIG. 2 is a flow chart illustrating a flow rate controlling step of the control method for the air fryer according to the above preferred embodiment of the present invention.

FIG. 3 is a flow chart illustrating a stepless speed control method for the air fryer according to the above preferred embodiment of the present invention.

FIG. 4 illustrates an example of the stepless control signal in the stepless speed control method according to the above preferred embodiment of the present invention.

FIG. 5 is a flow chart illustrating a power adjustment step in the stepless speed control method according to the above preferred embodiment of the present invention.

FIG. 6 is a schematic diagram illustrating an operational principle of the air fryer in the stepless speed control method according to the above preferred embodiment of the present invention.

FIG. 7 illustrates different graphs of the duty ratio change in the stepless speed control method according to the above preferred embodiment of the present invention.

FIG. 8 is a flow chart illustrating the signal modulation step in the stepless speed control method according to the above preferred embodiment of the present invention.

FIG. 9 is a graph illustrating a first example of the duty ratio modulation step in the stepless speed control method according to the above preferred embodiment of the present invention.

FIG. 10 is a flow chart illustrating a second example of the duty ratio modulation step in the stepless speed control method according to the above preferred embodiment of the present invention.

FIG. 11 illustrates an alternative mode of an operational principle of the air fryer in the stepless speed control method according to the above preferred embodiment of the present invention.

FIG. 12 is flow chart illustrating the power adjustment step in the alternative mode of the stepless speed control method according to the above preferred embodiment of the present invention.

FIG. 13 is a flow chart illustrating the signal modulation step in the alternative mode of the stepless speed control method according to the above preferred embodiment of the present invention.

FIG. 14 is a block diagram illustrating a control system for the air fryer according to the above preferred embodiment of the present invention.

FIG. 15 is a block diagram illustrating the stepless speed control system according to above preferred embodiment of the present invention.

FIG. 16 illustrates an alternative mode of the stepless speed control system according to the above preferred embodiment of the present invention.

FIG. 17 is block diagram illustrating an electronic device according to the above preferred embodiment of the present invention.

FIG. 18 is a block diagram of the air fryer according to the above preferred embodiment of the present invention.

FIG. 19 is a perspective view of the air fryer according to the above preferred embodiment of the present invention.

FIG. 20 is a sectional view of the air fryer according to the above preferred embodiment of the present invention.

FIG. 21 is an exploded perspective view of the air fryer according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

It is appreciated that the terms “longitudinal”, “transverse”, “upper”, “lower”, “front”, “rear”, “left”, “right”, vertical”, “horizontal”, “top”, “bottom”, “interior” and “exterior” in the following description refer to the orientation or positioning relationship in the accompanying drawings for easy understanding of the present invention without limiting the actual location or orientation of the present invention. Therefore, the above terms should not be an actual location limitation of the elements of the present invention.

It is appreciated that the terms “one” in the following description refer to “at least one” or “one or more” in the embodiment. In particular, the term “a” in one embodiment may refer to “one” while in another embodiment may refer to “more than one”. Therefore, the above terms should not be an actual numerical limitation of the elements of the present invention.

Accordingly, the existing air fryer generally comprises a switch, such as a mechanical relay, to control an operation of a fan, wherein the switch is arranged to switch the fan on and off via a switch circuit, such that the fan will either operate at full speed or at zero speed. In other words, when the existing air frying is initially powered on as a preheating stage, the fan will be operated at full speed to generate maximum air flow. As a result, it will take longer time for the existing air fryer to heat the air therein in order to reach the preset air temperature. In other words, the existing air fryer has poor air frying efficiency and quality so as to affect the air frying ability of the air fryer to air-fry the food. When the existing air fryer is operated to heat up the air at a constant temperature, i.e. the air in the housing is heated close to the preset temperature, the fan is still operated at the full speed, such that heat in the housing will be rapidly lost due to the operation of the fan. Therefore, the electric heater of the existing air fryer will be switched on frequently to re-heat the air in the housing. Such frequently switching on and off the electric heater will not only waste a lot of heat energy but also aggravate the fluctuation range of the air temperature in the housing so as to affect the air-frying process to cook the food, such as the appearance and the taste of the food.

Furthermore, since the fan of the existing air fryer is always operated at full speed for the air-frying different foods, the air flow rate in the existing air fryer is maintained at its maximum, such that the existing air fryer will always provide the maximum dehydration process and maximum fat reduction at all time. Especially for the food with low water content and low fat content, the food will be dried and hardened after it is air-fried by the existing air fryer so as to affect the appearance and the taste of the food.

Accordingly, in order to enhance the air frying ability, the air fryer is required to heat up the air rapidly to reach the preset temperature and to maintain the air temperature at the preset temperature in a constant manner. The air fryer is further required to provide different fan speeds according to different foods, that is different water contents and different fat contents, to optimize the dehydration and fat reduction process to match with the texture of the food. In order to achieve the above objectives, the present invention provides a control method and a stepless speed control method for an air fryer, wherein the air fryer of the present invention is able to selectively control the air flow rate according to a food-related parameter, such as the texture, of the food so as to optimize the dehydration and fat reduction process to air-fry the food. It is appreciated that the food to be air-fried in the present invention can be, but not limited to, foods such as French fries, vegetables, meat or fish, etc. It is appreciated that inedible industrial products can be placed in the air fryer of the present invention for surface heating, and it should not be limited in the present invention.

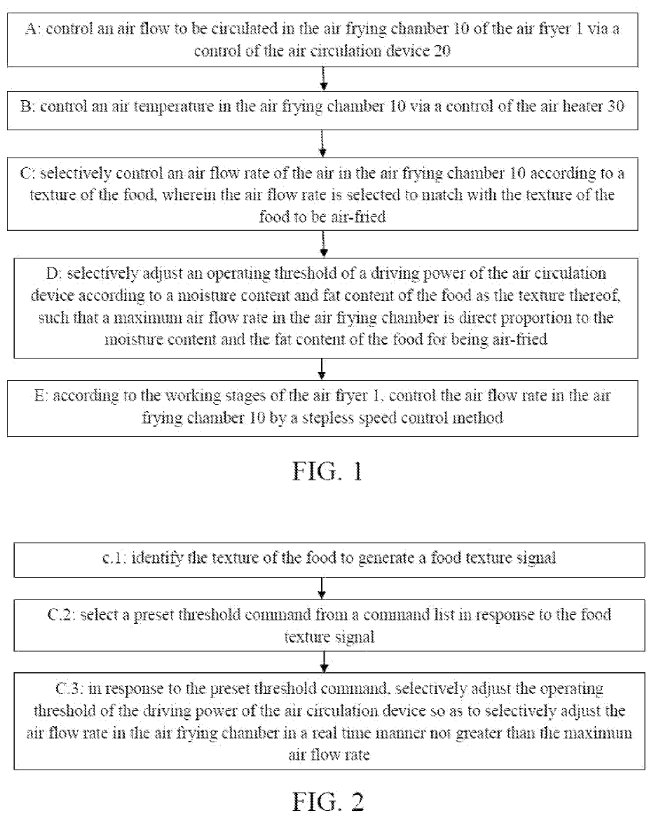

Referring to FIGS. 1 to 10 of the drawings, a control method for an air fryer according to a preferred embodiment of the present invention is illustrated, wherein the air fryer 1 has an air frying chamber 10 for receiving the food therein and comprises an air circulation device 20 for circulating air in the air frying chamber 10, and an air heater 30 for heating the air in the air frying chamber 10. Accordingly, after the food is placed in the air frying chamber 10, the air is heated by the air heater 30 and is circulated by the air circulation device 20 to air-fry the food in the air frying chamber 10.

It is appreciated that the air fryer 1 as shown in FIGS. 1 to 10 is an example to illustrate the features of the control method for the air fryer 1. The specific structural configuration of the air fryer 1 should not be limited in order to incorporate the control method of the present invention. In another example, the control method can be incorporated with different structural configurations of the air fryer 1 as long as the air fryer 1 can provide desired air frying process.

According to the preferred embodiment, as shown in FIG. 1, the control method for the air fryer 1 comprises the following steps.

(A) Control an air flow to be circulated in the air frying chamber 10 of the air fryer 1 via the control of the air circulation device 20.

(B) Control an air temperature in the air frying chamber 10 via the control of the air heater 30.

(C) Control selectively an air flow rate of the air in the air frying chamber 10 according to the texture of the food, wherein the air flow rate is selected to match with the food related parameter, i.e. the texture, of the food to be air-fried.

It is worth mentioning that since the control method for the air fryer according to the preferred embodiment is configured to selectively control the air flow rate of the air in the air frying chamber 10, the air flow rate is configured to directly determine the dehydration and fat reduction process for the food for air-frying the food. Therefore, the control method for the air fryer of the present invention is configured to match the air flow rate with the texture of the food, such as water content and/or fat content. For example, when the food has relative high water content or fat content, the control method for the air fryer is configured to increase the air flow rate to increase the dehydration efficiency and fat reduction efficiency of the food for being air-fried, so as to enhance the appearance and the taste of the food after being air-fried. When the food has relative low water content or fat content, the control method for the air fryer is configured to reduce the air flow rate to decrease the dehydration efficiency and fat reduction efficiency of the food for being air-fried so as to optimize the air-frying process for the food.

Furthermore, the driving power of the air circulation device 20 is directly proportion to the air flow rate of the air being driven by the air circulation device 20. In other words, the greater the driving power of the air circulation device 20, the greater the air flow rate of the air driven by the air circulation device 20. The air flow rate of the air frying chamber 10 is also greater, and vice versa.

Preferably, the step (c) of the control method further comprises a step of selectively adjusting an operating threshold of the driving power of the air circulation device 20 according to the texture of the food, wherein a maximum air flow rate of the air in the air frying chamber 10 is set to directly proportion to the water content and/or fat content of the food.

It is appreciated that the maximum air flow rate of the air is not relate to the air flow in the air frying chamber 10 at the full power of the air circulation device 20. The maximum air flow rate of the air is selectively adjusted by the control method of the present invention according to the texture of the food. In other words, different maximum air flow rates of the air are adjusted for different foods for being air-fried.

In one example, French fries as the food for being air-fried, wherein French fries have relative less water or fat content. The control method of the present invention is arranged to adjustably reduce the operating threshold of the driving power of the air circulation device 20 for decreasing the maximum air flow rate of the air in the air frying chamber 10, so as to prevent excessive air flow from causing excessive dehydration or fat reduction of food. For the food, such as meat, having relative high water or fat content, the control method of the present invention is arranged to adjustably increase the operating threshold of the driving power of the air circulation device 20 for increasing the maximum air flow rate of the air in the air frying chamber 10, so as to prevent insufficient air flow rate from causing insufficient dehydration or fat reduction of food.

It is worth mentioning that, in the examples of the present invention, the control method is configured based on the texture of the food. Via a control interface of the air fryer 1, such as a touch screen or buttons, the operating threshold of the driving power of the air circulation device 20 can be selectively adjusted. In other words, the maximum air flow rate of the air in the air frying chamber 10 can be manually adjusted according to the texture of the food in the control method of the present invention.

In another example the control method for the air fryer can be also configured to intelligently control the air circulation device 20 based on the texture of the food, wherein the operating threshold of the driving power of the air circulation device 20 can be selectively adjusted by an intelligent circuit of the air fryer 1 by pre-storing different food data therein. In other words, the maximum air flow rate of the air in the air frying chamber 10 can be automatically adjusted according to the texture of the food in the control method of the present invention. For example, the air fryer 1 of the present invention can detect the texture of the food in order to selectively adjust the operating threshold of the driving power of the air circulation device 20.

Particularly, according to the preferred embodiment, as shown in FIG. 2, the step (C) further comprises the following steps.

(C.1) Identify the texture of the food to generate a food texture parameter.

(C.2) Select a preset threshold command from a command list in response to the food texture parameter.

(C.3) In response to the preset threshold command, selectively adjust the operating threshold of the driving power of the air circulation device 20 so as to selectively adjust the air flow rate in the air frying chamber 10 not higher than the maximum air flow rate.

It is worth mentioning that, in the step (C.1) of the control method for the air fryer of the present application, the food identification can be performed, but not limited to, through empirical judgment, machine camera detection, or component detection. It is appreciated that the command list contains different food texture data preset by the manufacturers or can be obtained from big data through Internet.

Furthermore, since the driving power of the air circulation device 20 can be selectively adjust by modulating a parameter of a stepless control signal, the step (c.3) of the control method further comprises a step of selectively adjusting the driving power of the air circulation device 20 can be selectively adjust by modulating a parameter of a stepless control signal within a parameter modulation range.

In other words, when the operating threshold of the driving power of the air circulation device 20 is required for being reduced, only a smaller parameter modulation range is required for being set. Then, by modulating the parameters of the stepless control signal within the parameter modulation range, the driving power of the air circulation device 20 will not be greater than the preset threshold. Likewise, when the operating threshold of the driving power of the air circulation device 20 is required for being increased, only a larger parameter modulation range is required for being set.

It is worth mentioning that since different foods have different textures, different foods and different temperature sensitivities. In order to target different foods for being air-fried, a maximum air temperature of the air is selectively regulated in the air frying chamber 10 to prevent any overheating of the food or even burnt the food due to the high air temperature. Particularly, according to the preferred embodiment as shown in FIG. 1, the control method for the air fryer further comprises the following step.

(D) Selectively adjust the maximum air temperature of the air in the air frying chamber 10 according to the texture of the food in the air frying chamber 10, to optimize the maximum air temperature for air-frying the food.

Furthermore, the air frying process of the air fryer 1 can be divided into different working stages. When the air fryer 1 is operated in different working stages, the air circulation device 20 of the air fryer 1 is operated to controllably adjust the air flow rate in the air frying chamber 10 to improve the air frying ability of the air fryer 1. As shown in FIG. 1, the control method for the air fryer further comprises the following step.

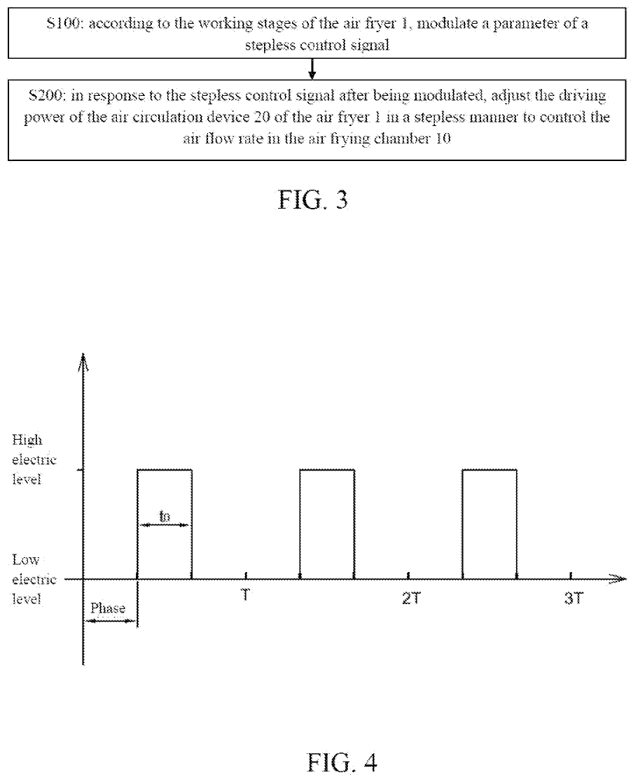

(E) According to the working stage of the air fryer 1, controlling the air flow rate in the air frying chamber 10 via the stepless speed control method to improve the air frying ability of the air fryer 1. Particularly, as shown in FIG. 3, the stepless speed control method further comprises the following steps.

S100: Modulate the parameters of the stepless control signal according to the working stage of the air fryer 1.

S200: In response to the stepless control signal after being modulated, adjust the driving power of the air circulation device 20 of the air fryer 1 in a stepless manner to control the air flow rate in the air frying chamber 10, so as to fulfill the requirement of the air frying process.

Preferably, in the step (D) of the control method for the air fryer of the present invention, the stepless speed control method is configured to modulate the parameters of the stepless control signal within the parameter modulation range, such that the real-time driving power of the air circulation device 20 is not higher than the preset threshold.

It is worth mentioning that, as shown in FIG. 6, the air circulation device 20 of the air fryer 1, but is not limited to, comprises a power supply circuit 21 for operatively connecting with a power source E, a fan 22 electrically connected to the power supply circuit 21, and a speed adjustment device 23 operatively connected to the power supply circuit 21 for selectively controlling a rotational speed of the fan 22 in a real time manner in response to the stepless control signal, so as to control the driving power of the stepless adjustment of the air circulation device 20. It is appreciated that the fan 22 can be incorporated with a DC motor unit or AC motor unit.

Particular, the stepless speed control method of the present invention is configured to adjust the driving power of the air circulation device 20 in a stepless manner through the stepless control signal, wherein the air circulation device 20 can be operated between zero driving power and full driving power. In other words, through the stepless speed control method of the present invention, the fan 22 of the air circulation device 20 can be operated at any speed between the full speed operation (corresponding to the full power working stage of the air circulation device 20) and the stop running operation (corresponding to the zero-power working stage of the air circulation device 20). Furthermore, the air flow rate of the air in the air frying chamber 10 is continuously adjusted. Comparing to the existing air fryer, the fan thereof can only be operated at full speed throughout the entire air frying process. Therefore, the stepless speed control method of the present invention enables the air flow rate and air temperature in the air fryer 1 to enhance the air frying process.

Preferably, as shown in FIG. 4, the stepless control signal of the present invention can be implemented as a pulse wave, wherein the parameter of the stepless control signal can be, but is not limited to, the duty ratio of the pulse wave or frequency. It is appreciated that the pulse wave can be implemented as, but not limited to, a rectangular wave, a saw-tooth wave, a triangular wave, a spike wave, a step wave, etc. For easy understanding, the rectangular wave is taken as an example for illustration in the present invention. Furthermore, the duty ratio of the pulse wave refers to the ratio between the pulse width (i.e. the time to corresponding to the high electrical level of the pulse wave within a pulse period T) and the pulse period T, i.e. to/T.

As an example in FIG. 6, the speed adjustment device 23 of the air circulation device 20 comprises a switching unit 231, wherein the switching unit 231 and the fan 22 are electrically connected to the power supply circuit 21 in series connection, such that in response to the stepless control signal, the power supply circuit is electrically opened and closed in a real time manner to selectively adjust the rotational speed of the fan 23 in a real time manner, such that the driving power of the air circulation device 20 can be adjusted in a stepless manner.

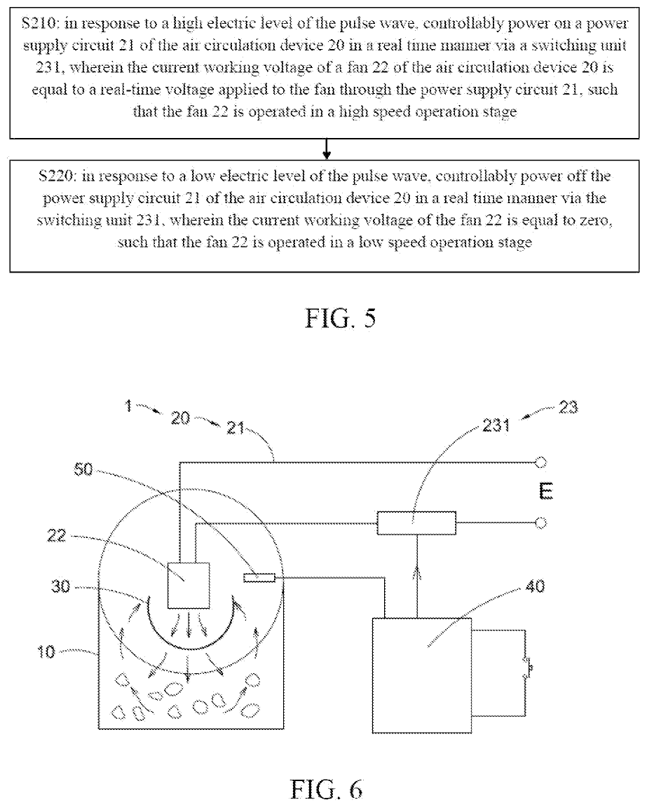

Particularly, as shown in FIG. 5, the stepless speed control method further comprises the following steps.

S210: In response to the high electric level of the pulse wave, controllably power on the power supply circuit 21 of the air circulation device 20 in a real time manner via the switching unit 231, wherein the current working voltage of the fan 22 is equal to the real-time voltage applied to the fan 22 through the power supply circuit 21, such that the fan 22 is operated in a high speed operation stage.

S220: In response to the low electric level of the pulse wave, controllably power off the power supply circuit 21 of the air circulation device 20 in a real time manner via the switching unit 231, wherein the current working voltage of the fan 22 is equal to zero, such that the fan 22 is operated in a low speed operation stage.

It is worth mentioning that when the duty ratio of the pulse wave is increased, the pulse time of the pulse wave becomes longer. The time of the fan 22 of the air circulation device 20 being operated in a high speed stage within on pulse period is prolonged. The time of the fan 22 of the air circulation device 20 being operated in a low speed stage within on pulse period is shortened. As a result, the effective rotational speed of the fan 22 in one pulse period will be increased. Therefore, the driving power of the air circulation device 20 is increased, such that the air flow rate of the air driven by the air circulation device 20 will be larger correspondingly. Likewise, when the duty ratio of the pulse wave is reduced, the pulse time of the pulse wave becomes shorter. The time of the fan 22 of the air circulation device 20 being operated in a high speed stage within on pulse period is shortened. The time of the fan 22 of the air circulation device 20 being operated in a low speed stage within on pulse period is prolonged. As a result, the effective rotational speed of the fan 22 in one pulse period will be decreased. Therefore, the driving power of the air circulation device 20 is decreased, such that the air flow rate of the air driven by the air circulation device 20 will be smaller correspondingly.

It is appreciated that the pulse frequency of the stepless control signal of the present invention is set above 50 Hz. In other words, the frequency of switching state of the fan 22 of the air circulation device 20 is also set above 50 HZ (that is, the fan 22 will switch its states at least once within 20 ms), to improve the accuracy of adjusting the driving power of the air circulation device 20. In another example, the pulse frequency of the stepless control signal may also be set below 50 Hz.

Preferably, the switching unit 231 is embodied as a solid state relay to power on and off the power supply circuit 21 in a high frequency manner and to directly drive a large current load (such as the fan 22) through the small stepless control signal. It is worth mentioning even though the conventional mechanical relay can also power on and off the power supply circuit 21, there will be a huge transient current at the same time during the power on or off operation. As a result, the conventional mechanical relay will produce electric sparks during the power on or off operation, which will damage the relay, and there is a safety concern. Furthermore, the conventional mechanical relay has relatively long action time, which cannot incorporate with the stepless speed control method of the present invention for high-frequency switching or real time switching operation.

It is worth mentioning that in daily life, the power source for the air fryer 1 is powered by an alternating current, wherein as an example, AC power with a frequency of 50 HZ is usually used in China, and AC power with a frequency of 60 HZ is usually used in the United States. Therefore, when the power supply circuit 21 of the air circulation device 20 is powered on by the switching unit 231 of the air circulation device 20 in a real time manner, the current operating voltage of the fan 22 of the air circulation device 20 will also alter over the time, such that the effective working voltage of the fan 22 will be changed along with the change of the duty ratio of the stepless control signal.

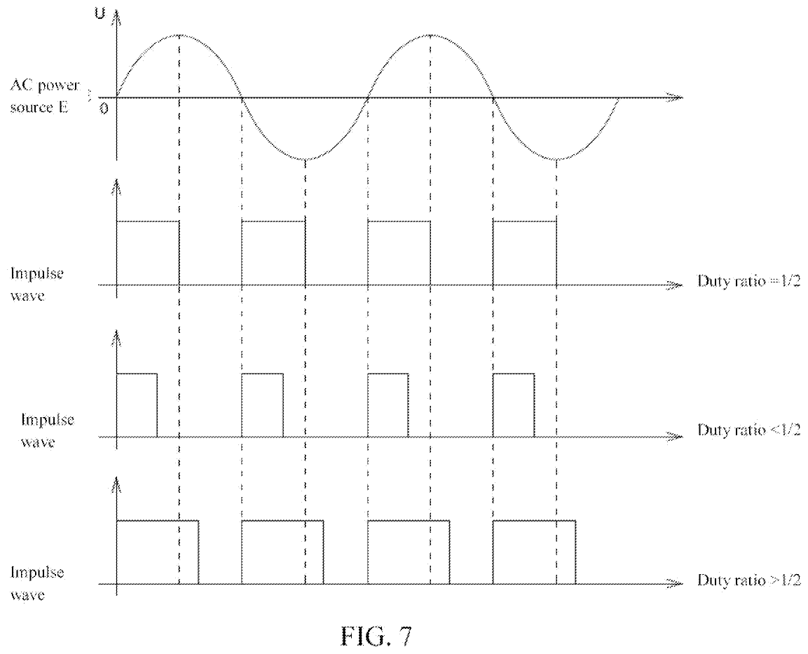

As shown in FIG. 7, assuming that the power supply E provides 50 HZ alternating current, and the stepless control signal has a pulse wave with a frequency of 100 HZ as an example. When the duty ratio of the stepless control signal is adjusted at ½, the effective working voltage of the fan 22 is equal to half of the effective voltage of the power supply E. When the duty ratio of the stepless control signal is adjusted lesser than ½, the effective working voltage of the fan 22 becomes smaller and is less than half of the effective voltage of the power supply E, such that the driving power of the air circulation device 20 is reduced, i.e. the rotational speed of the fan 22 is reduced. When the duty ratio of the stepless control signal is adjusted greater than ½, the effective working voltage of the fan 22 becomes larger and is greater than half of the effective voltage of the power supply E, such that the driving power of the air circulation device 20 is increased, i.e. the rotational speed of the fan 22 is increased.

It is worth mentioning that the stepless speed control method of the present application is divided into four working stages in the working process of the air fryer 1. The four working stages are a preheating stage, a primary heating stage, a constant temperature heating stage and a cooling stage in sequence. Particularly, when the air fryer 1 is operated in the preheating stage, the air heater 30 of the air fryer 1 starts operating to heat up the air therein. Due to the low air temperature in the air fryer 1, the heating efficiency of the air is relatively low, such that the fan 22 is stopped rotating in the preheating stage to ensure the air temperature in the air fryer 1 being increased rapidly by the air heater 30. When the air fryer 1 is operated in the primary heating stage, the temperature of the air heater 30 of the air fryer 1 is relatively high. However, the temperature difference between the air temperature in the air frying chamber 10 and the temperature of the air heater 30 is relatively large. Meanwhile, the fan 22 is required for operating (such as at full speed, etc) in order to reduce the temperature difference in the air frying chamber 10, so as to ensure the consistency of the air temperature at any portion of the air frying chamber 10. When the air fryer 1 is operated in the constant temperature heating stage, the air temperature in the entire air frying chamber 10 reaches the preset target temperature. At this time, the speed of the fan 22 will be reduced to minimize the heat loss, such that the air temperature in the air frying chamber 10 will be maintained between the upper limit and the lower limit of the preset target temperature. When the air fryer 1 is operated in the cooling stage, the air heater 30 of the air fryer 1 will stop operating to stop heating the air. Due to the high temperature of the air heater 30, the air heater 30 will keep heating up the air at the time when the air heater 30 is just stopped operating. At this time, the fan 22 is required for being rotated at full speed to ensure that the temperature of the air heater 30 and the air temperature in the air frying chamber 10 being rapidly reduced, so as to allow the food being taken out of the air frying chamber 10.

Preferably, the stepless speed control method of the present application can divide the working stages of the air fryer 1 in response to an operating time. For example, the air fryer 1 is in the preheating stage for one minute of the operating time after the air fryer 1 is started. The air fryer 1 is in the primary heating stage from the 1st to 5th minute of the operation time after the air fryer 1 is started. The air fryer 1 is in the constant temperature heating stage from the 5th to the 25th minute of the operation time after the air fryer 1 is started. The air fryer 1 is in the cooling stage from the 25th minute to the 30th minute of the operation time after the air fryer 1 is started. It is appreciated that the operating time length of each working stage of the air fryer 1 is selectively adjusted according to the texture of the food or the pre-setting of the air fryer 1.

Alternatively, the stepless speed control method of the present application can divide the working stages of the air fryer 1 in response to an operating temperature. For example, the air fryer 1 is in the preheating stage after the air fryer 1 is started until the temperature of the air heater 30 reaches a predetermined heating temperature (such as 300° C.). The air fryer 1 is in the primary heating stage when the temperature of the air heater 30 reaches the predetermined heating temperature and the air temperature in the air frying chamber 10 reaches the preset target temperature. The air fryer 1 is in the constant temperature heating stage when the air temperature in the air frying chamber 10 reaches the preset target temperature for a predetermined operating time. After the predetermined operating time of maintaining the air temperature in the air frying chamber 10 at the preset target temperature, the air heater 30 is controllably operated to cool down its operating temperature to a predetermined cooling temperature (such as 40° C.), such that the air fryer 1 is in the cooling stage.

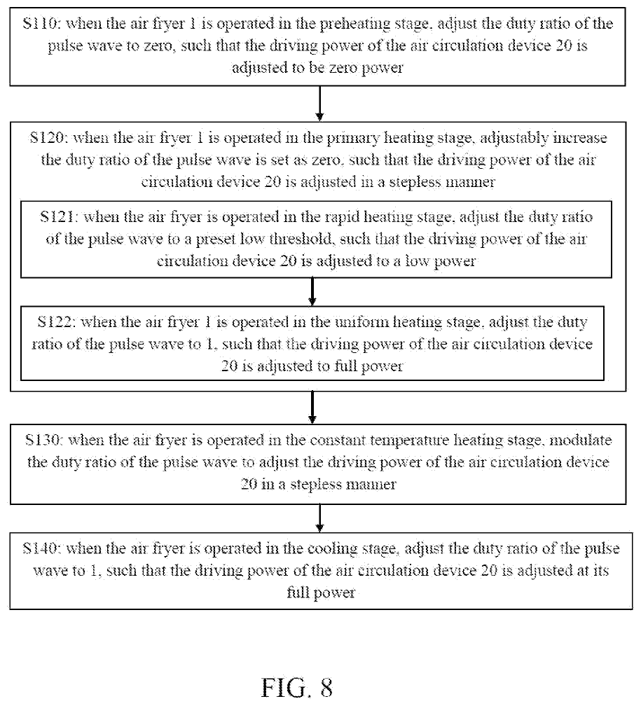

As shown in FIG. 8, the step (S100) of the stepless speed control method further comprises the following steps.

S110: When the air fryer 1 is operated in the preheating stage, adjust the duty ratio of the pulse wave to zero, such that the driving power of the air circulation device is adjusted to be zero power.

S120: When the air fryer 1 is operated in the primary heating stage, adjustably increase the duty ratio of the pulse wave is set as zero, such that the driving power of the air circulation device is adjusted in a stepless manner.

S130: When the air fryer 1 is operated in the constant temperature heating stage, modulate the duty ratio of the pulse wave to adjust the driving power of the air circulation device 20 in a stepless manner.

S140: When the air fryer 1 is operated in the cooling stage, adjust the duty ratio of the pulse wave to 1, such that the driving power of the air circulation device 20 is adjusted at its full power.

It is worth mentioning that when the air fryer 1 is operated in the primary heating stage, the initial air temperature in the air frying chamber 10 is relatively low. At this time, the air fryer 1 is required for rapidly increasing the air temperature in the air frying chamber 10, such that the fan 22 of the air circulation device 20 is required to rotate at a low speed to circulate the air in the air frying chamber 10 at a low speed for allowing the air temperature in the air frying chamber 10 to be increased rapidly. As the air temperature in the air frying chamber 10 increases close to the preset target temperature, the air fryer 1 is required to maintain the air temperature in the air frying chamber 10 consistently. Therefore, the fan 22 of the air circulation device 20 is required to rotate at full speed to circulate the air in the air frying chamber 10 rapidly for maintaining the air temperature in the air frying chamber 10 consistently.

Preferably, the primary heating stage of the air fryer 1 can further be divided into a rapid heating stage and a uniform heating stage after the rapid heating stage. When the air fryer 1 is operated in the rapid heating stage, the fan 22 of the air circulation device 20 is operated to rotate at a low speed. When the air fryer 1 is operated in the uniform heating stage, the fan 22 of the air circulation device 20 is operated to rotate at full speed. It is appreciated that the primary heating stage can be divided according to different factors such as time or temperature to define the rapid heating stage and the uniform heating stage. For example, the rapid heating stage is switched to the uniform heating stage when the air temperature in the air frying chamber 10 reaches 90-95% of the preset target temperature.

As shown in FIG. 8, the step (S120) of the stepless speed control method further comprises the following steps.

S121: When the air fryer 1 is operated in the rapid heating stage, adjust the duty ratio of the pulse wave to a preset low threshold, such that the driving power of the air circulation device 20 is adjusted to a low power.

S122: When the air fryer 1 is operated in the uniform heating stage, adjust the duty ratio of the pulse wave to 1, such that the driving power of the air circulation device 20 is adjusted to full power.

Preferably, the preset low threshold can be set as 0.4 to 0.6. For example, the preset low threshold can be set as 0.5, i.e. the duty ratio of the pulse wave is equal to 0.5, such that the air circulation device 20 is in a half-power working mode.

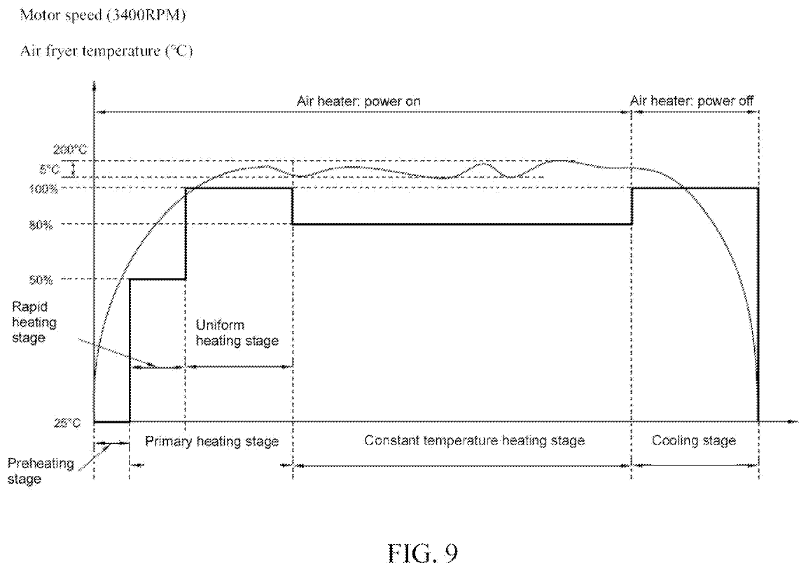

It is worth mentioning that, as the first example in FIG. 9, when the air fryer 1 is operated in the constant temperature heating stage, the air fryer 1 is able to maintain the air temperature in the air frying chamber 10 between the upper and lower limits of the preset target temperature by adjusting the heating power of the air heater 30, such that the fluctuation of the air temperature in the air frying chamber 10 is minimized. The stepless speed control method only needs to adjust the driving power of the air circulation device 20 when the air fryer 1 is operated in the constant temperature heating stage, such that the heat dissipation power of the air fryer 1 is substantially equal to the heating power of the air heater 30 so as to reduce the fluctuation of the air temperature in the air frying chamber 10.

As shown in FIG. 9, according to the preferred embodiment, in the step (S130) of the stepless speed control method, when the air fryer 1 is operated in the constant temperature heating stage, the duty ratio of the pulse wave is adjusted to a preset high threshold to adjust the driving power of the air circulation device 20 to a high power, such that the heat dissipation power of the air fryer 1 is substantially equal to the heating power of the air heater 30.

Preferably, the preset high threshold can be set as 0.7 to 0.9. For example, the preset high threshold can be set as 0.8, i.e. the duty ratio of the pulse wave is equal to 0.8, such that the heat dissipation power of the air fryer 1 is substantially equal to the heating power of the air heater 30.

According to the second example of the present invention, when the air fryer 1 is operated in the constant temperature heating stage, the air fryer 1 can also adjust the driving power of the air circulation device 20 to maintain the air temperature in the air fryer cavity 10 at the desired level between the upper and lower limits of the preset target temperature, so as to reduce the fluctuation of the air temperature in the air frying chamber 10. At this time, the air fryer 1 may not require for adjusting the heating power of the air heater 30, wherein the stepless speed control method is required for only controlling the air fryer 1 in the constant temperature heating stage in response to the air temperature change in the air frying chamber 10. Correspondingly adjusting the driving power of the air circulation device 20, the air temperature in the air frying chamber 10 can be maintained between the upper and lower limits of the preset target temperature.

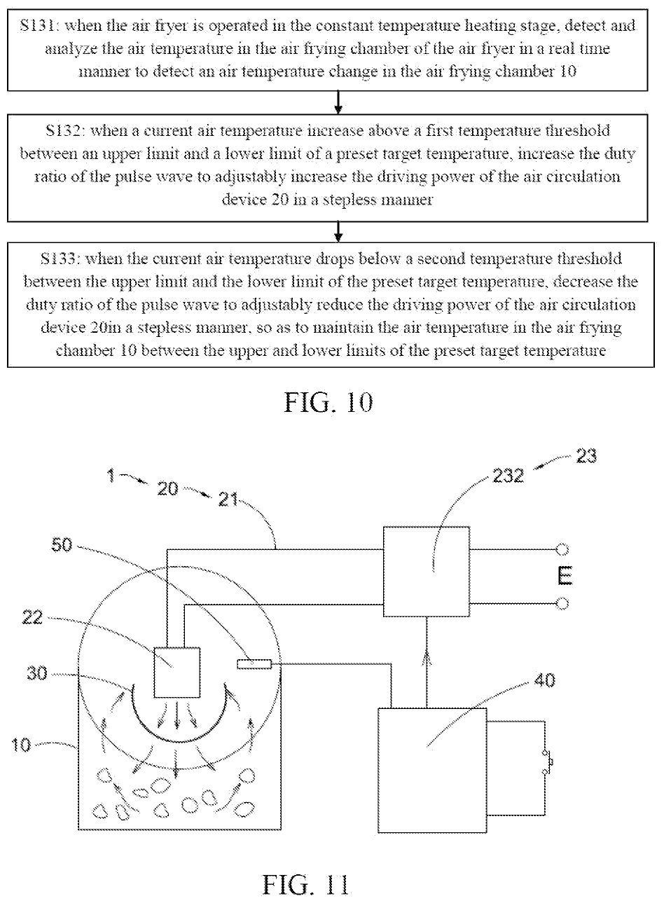

As shown in FIG. 10, according to the second example of the present invention, step (S130) of the stepless speed control method further comprises the following steps.

S131: When the air fryer 1 is operated in the constant temperature heating stage, detect and analyze the air temperature in the air frying chamber 10 of the air fryer 1 in a real time manner to detect an air temperature change in the air frying chamber 10 so as to obtain the current air temperature therein.

S132: When the current air temperature increases above a first temperature threshold between the upper limit and the lower limit of the preset target temperature, increase the duty ratio of the pulse wave to adjustably increase the driving power of the air circulation device 20 in a stepless manner.

S133: When the current air temperature drops below a second temperature threshold between the upper limit and the lower limit of the preset target temperature, decrease the duty ratio of the pulse wave to adjustably reduce the driving power of the air circulation device 20 in a stepless manner, so as to maintain the air temperature in the air frying chamber 10 between the upper and lower limits of the preset target temperature.

Preferably, the first temperature threshold and the second temperature threshold can be set as the preset target temperature to further reduce the upper limit and the lower limit of the preset target temperature. Alternatively, in another example of the present invention, the first temperature threshold can be set at any temperature between the preset target temperature and the upper limit of the preset target temperature while the second temperature threshold can be set at any temperature between the lower limit of the preset target temperature and the preset target temperature.

It is worth mentioning that FIGS. 11 to 13 illustrates an alternative mode of the stepless speed control method as a modification thereof according to the above preferred embodiment of the present invention, wherein the parameters of the stepless control signal can, but not limited to, include the frequency of the pulse wave. Accordingly, the speed adjustment device 23 of the air circulation device 10 comprises a frequency converter 232 for converting the stepless control signal, wherein the frequency converter 232 and the fan 22 are electrically connected to the power supply circuit 21. The frequency of the power supplied to the fan 23 via the power supply circuit 21 is adjusted in a real time manner by the frequency converter 232, to adjust the rotational speed of the fan 23 in a real time manner so as to adjust the driving power of the air circulation device 20 in a stepless manner.

It is appreciated that since the frequency converter 232 is embodied as an electrical energy control device that uses the on-off action of a power semiconductor device to convert a working power frequency into another frequency, the frequency of the power supplied to the fan 23 via the power supply circuit 21 can be directly proportion to the frequency of the stepless control signal by adjusting the frequency of the power supply to the fan 23 via the power supply circuit 21 via the frequency converter 232. In other words, when the frequency of the pulse wave is increased, the frequency of the power supplied to the fan 23 via the power supply circuit 21 is adjusted in a real time manner by the frequency converter 232, such that the frequency of the power supplied to the fan 23 is increased correspondingly. When the frequency of the pulse wave is adjusted to be decreased, the frequency of the power supplied to the fan 23 via the power supply circuit 21 is adjusted in a real time manner by the frequency converter 232, such that the frequency of the power supplied to the fan 23 is decreased correspondingly.

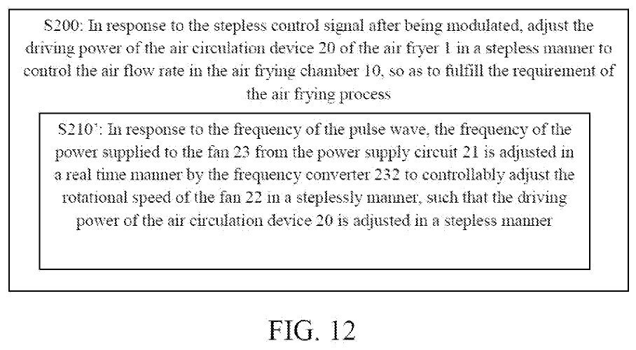

As shown in FIG. 12, according to the alternative mode of the preferred embodiment, the step (S200) in the stepless speed control method further comprises the following step.

S210′: In response to the frequency of the pulse wave, the frequency of the power supplied to the fan 23 from the power supply circuit 21 is adjusted in a real time manner by the frequency converter 232 to controllably adjust the rotational speed of the fan 22 in a stepless manner, such that the driving power of the air circulation device 20 is adjusted in a stepless manner.

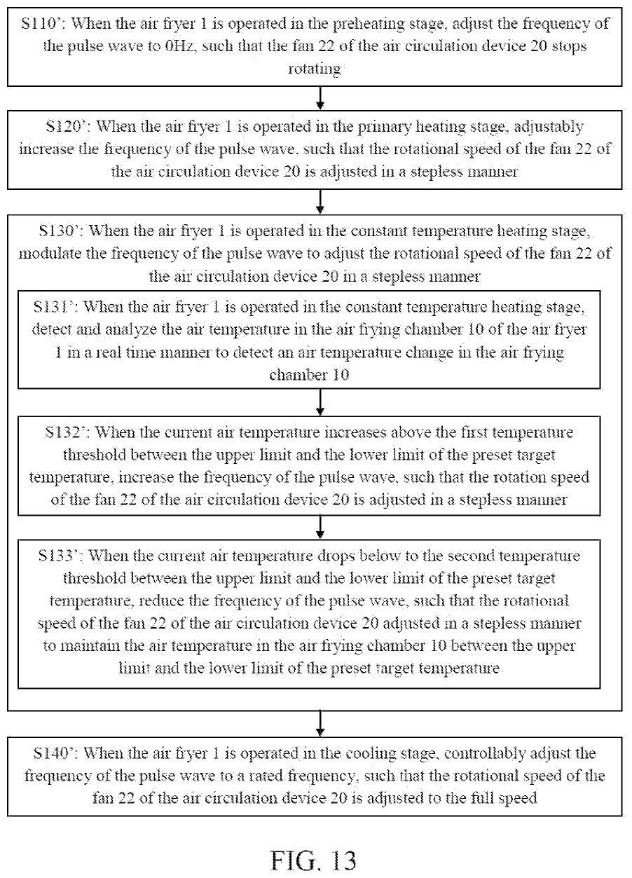

As shown in FIG. 13, the step (S100) in the stepless speed control method further comprises the following steps.

S110′: When the air fryer 1 is operated in the preheating stage, adjust the frequency of the pulse wave to 0 Hz, such that the fan 22 of the air circulation device 20 stops rotating, i.e. the rotational speed of the fan 22 is zero.

S120′: When the air fryer 1 is operated in the primary heating stage, adjustably increase the frequency of the pulse wave, such that the rotational speed of the fan 22 of the air circulation device 20 is adjusted in a stepless manner.

S130′: When the air fryer 1 is operated in the constant temperature heating stage, modulate the frequency of the pulse wave to adjust the rotational speed of the fan 22 of the air circulation device 20 in a stepless manner.

S140′: When the air fryer 1 is operated in the cooling stage, controllably adjust the frequency of the pulse wave to a rated frequency, such that the rotational speed of the fan 22 of the air circulation device 20 is adjusted to the full speed.

Preferably, as shown in FIG. 13, the step (S130′) in the stepless speed control method further comprises the following steps.

S131′: When the air fryer 1 is operated in the constant temperature heating stage, detect and analyze the air temperature in the air frying chamber 10 of the air fryer 1 in a real time manner to detect an air temperature change in the air frying chamber 10.

S132′: When the current air temperature increases above the first temperature threshold between the upper limit and the lower limit of the preset target temperature, increase the frequency of the pulse wave, such that the rotation speed of the fan 22 of the air circulation device 20 is adjusted in a stepless manner.

S133′: When the current air temperature drops below to the second temperature threshold between the upper limit and the lower limit of the preset target temperature, reduce the frequency of the pulse wave, such that the rotational speed of the fan 22 of the air circulation device 20 adjusted in a stepless manner to maintain the air temperature in the air frying chamber 10 between the upper limit and the lower limit of the preset target temperature.

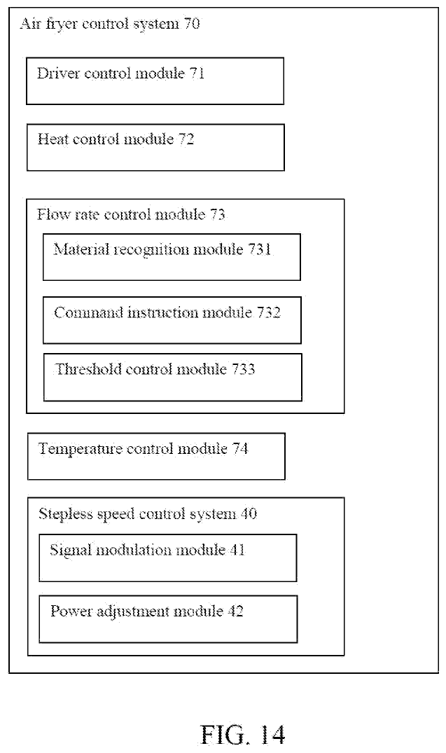

As shown in FIG. 14, a control system for the air fryer according to the preferred embodiment of the present invention is illustrated, wherein the control system 70 is control to the air frying process of the air fryer 1 at different working stages. The control system 70 comprises a driver control module 71, a heat control module 72 and a flow rate control module 73 operatively connected with each other. Accordingly, the driver control module 71 is configured to control the air circulation device of the air fryer to drive the air circulating in an air frying chamber of the air fryer. The heat control module 72 is configured to control the air heater of the air fryer to heat the air in the air frying chamber. The flow rate control module 73 is configured to selectively adjust the air flow rate in the air frying chamber according to the texture of the food to be air-fried in the air frying chamber, so as to match the air flow rate with the texture of the food.

It is worth mentioning that, according to the preferred embodiment as shown in FIG. 14, the flow rate control module 73 comprises a material recognition module 731, a command instruction module 732, and a threshold control module 733 operatively connected with each other. Accordingly, the material identification module 731 is configured to identify the material or texture of the food to be air-fried to obtain a material identification result. The command instruction module 732 is configured to select the preset threshold command from the command list in response to the material recognition result. The threshold control module 733 is configured to adjust the operating threshold of the driving power of the air circulation device to be equal to a predetermined threshold in response to the preset threshold instruction, such that the air flow rate in the air frying chamber is adjusted in a real time manner not higher than the maximum air flow rate.

In one example of the present invention as shown in FIG. 14, the control system 70 further comprises a temperature control module 74 configured to selectively adjust the maximum air temperature in the air frying chamber according to the texture of the food therein, so as to match the maximum air temperature with the food for being air-fried.

In one example of the present invention as shown in FIG. 14, the control system 70 further comprises a stepless speed control system 40, wherein the stepless speed control system 40 comprises a signal modulation module 41 and a power adjustment module 42 operatively connected with each other. The signal modulation module 41 is configured to modulate the parameter of the stepless control signal according to the working stage of the air fryer 1. The power adjustment module 42 is configured to adjust the driving power of the air circulation device 20 in a stepless manner in response to the stepless control signal after being modulated, so as to control the air flow rate in the air frying chamber 10.

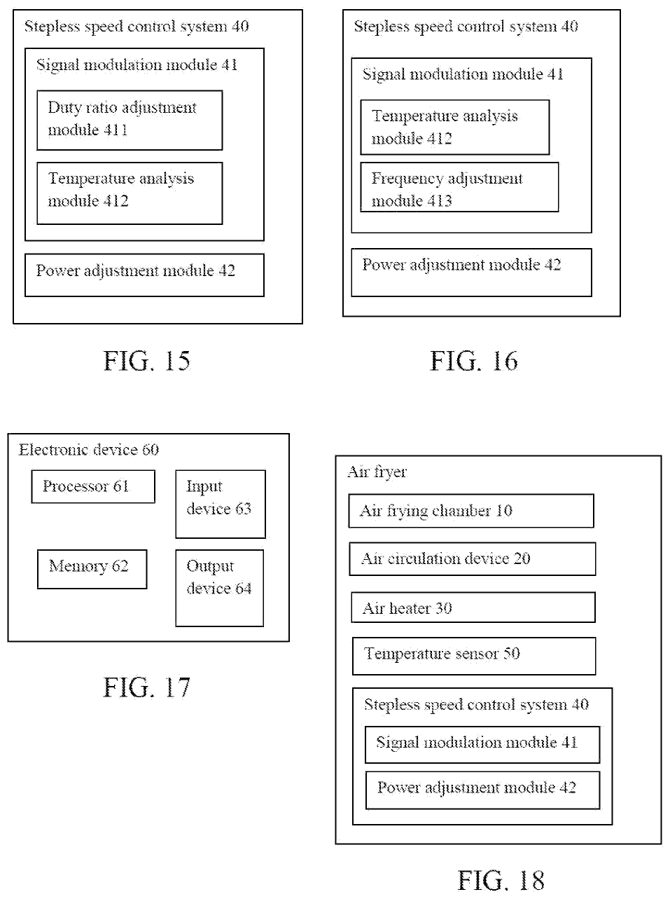

As shown in FIG. 15, the stepless speed control system according to the preferred embodiment of the present invention is illustrated and is configured for being used in the air fryer 1. The air fryer 1 has the air frying chamber 10 for receiving the food therein and comprises the air circulation device 20 for circulating air in the air frying chamber 10, and the air heater 30 for heating the air in the air frying chamber 10.

Particularly, as shown in FIG. 15, the stepless speed control system 40 comprises the signal modulation module 41 and the power adjustment module 42 operatively connected with each other. The signal modulation module 41 is configured to modulate the parameter of the stepless control signal according to the working stage of the air fryer 1. The power adjustment module 42 is configured to adjust the driving power of the air circulation device 20 in a stepless manner in response to the stepless control signal after being modulated, so as to control the air flow rate in the air frying chamber 10.

It is worth mentioning that the stepless control signal according to the preferred embodiment can be implemented as a pulse wave, wherein the parameter of the stepless control signal can be the duty ratio of the pulse wave.

Particularly, as shown in FIGS. 6 and 15, the power adjustment module 42 is further configured to: in response to the high electric level of the pulse wave, controllably power on the power supply circuit 21 of the air circulation device 20 in a real time manner via the switching unit 231, wherein the current working voltage of the fan 22 is equal to the real-time voltage applied to the fan 22 through the power supply circuit 21, such that the fan 22 is operated in a high speed operation stage; and in response to the low electric level of the pulse wave, controllably power off the power supply circuit 21 of the air circulation device 20 in a real time manner via the switching unit 231, wherein the current working voltage of the fan 22 is equal to zero, such that the fan 22 is operated in a low speed operation stage.

According to the preferred embodiment, the signal modulation module 41 further comprises a duty ratio adjustment module 411 configured to: when the air fryer 1 is operated in the preheating stage, adjust the duty ratio of the pulse wave to zero, such that the driving power of the air circulation device is adjusted to be zero power; when the air fryer 1 is operated in the primary heating stage, adjustably increase the duty ratio of the pulse wave is set as zero, such that the driving power of the air circulation device is adjusted in a stepless manner; when the air fryer 1 is operated in the constant temperature heating stage, modulate the duty ratio of the pulse wave to adjust the driving power of the air circulation device 20 in a stepless manner; and when the air fryer 1 is operated in the cooling stage, adjust the duty ratio of the pulse wave to 1, such that the driving power of the air circulation device 20 can be adjusted at its full power.

In one example, the duty ratio adjustment module 411 is further configured to: when the air fryer 1 is operated in the rapid heating stage, adjust the duty ratio of the pulse wave to a preset low threshold, such that the driving power of the air circulation device 20 is adjusted to a low power; and when the air fryer 1 is operated in the uniform heating stage, adjust the duty ratio of the pulse wave to 1, such that the driving power of the air circulation device 20 is adjusted to full power.

In another example, the duty ratio adjustment module 411 is further configured to: when the air fryer 1 is operated in the constant temperature heating stage, the duty ratio of the pulse wave is adjusted to the preset high threshold to adjust the driving power of the air circulation device 20 to a high power, such that the heat dissipation power of the air fryer 1 is substantially equal to the heating power of the air heater 30.

According to the preferred embodiment, as shown in FIG. 15, the signal modulation module 41 further comprises a temperature analysis module 412 operatively connected to the duty ratio adjustment module 411, wherein the temperature analysis module 412 is configured to detect and analyze the air temperature in the air frying chamber 10 of the air fryer 1 in a real time manner when the air fryer 1 in the constant temperature heating stage, so as to detect an air temperature change in the air frying chamber 10. The duty ratio adjustment module 411 is further configured to increase the duty ratio of the pulse wave when he current air temperature of the air increase above a first temperature threshold between the upper limit and the lower limit of the preset target temperature, so as to adjustably increase the driving power of the air circulation device 20 in a stepless manner; and decrease the duty ratio of the pulse wave to adjustably reduce the driving power of the air circulation device 20 in a stepless manner when the current air temperature of the air drops below a second temperature threshold between the upper limit and the lower limit of the preset target temperature, so as to maintain the air temperature in the air frying chamber 10 between the upper and lower limits of the preset target temperature.

It is worth mentioning that FIG. 16 illustrates an alternative mode of the stepless speed control system according to the preferred embodiment as a modification. Particularly, the difference between the preferred embodiment and the alternative mode of the stepless speed control system 40 is that the stepless control signal is a pulse wave, and the parameter of the stepless control signal includes the frequency of the pulse wave.

According to the preferred embodiment, as shown in FIGS. 11 and 16, the power adjustment module 42 is further configured to: in response to the frequency of the pulse wave, adjust the frequency of the power supplied to the fan 23 via the power supply circuit 21 in a real time manner by the frequency converter 232 for adjusting the rotational speed of the fan 23 in a real time manner so as to adjust the driving power of the air circulation device 20 in a stepless manner.

According to the preferred embodiment, as shown in FIG. 16, the signal modulation module 41 further comprises a frequency adjustment module 413 configured to: when the air fryer 1 is operated in the preheating stage, adjust the frequency of the pulse wave to 0 Hz, such that the fan 22 of the air circulation device 20 stops rotating; when the air fryer 1 is operated in the primary heating stage, adjustably increase the frequency of the pulse wave, such that the rotational speed of the fan 22 of the air circulation device 20 is adjusted in a stepless manner; when the air fryer 1 is operated in the constant temperature heating stage, modulate the frequency of the pulse wave to adjust the rotational speed of the fan 22 of the air circulation device 20 in a stepless manner; and when the air fryer 1 is operated in the cooling stage, controllably adjust the frequency of the pulse wave to a rated frequency, such that the rotational speed of the fan 22 of the air circulation device 20 is adjusted to the full speed.

Preferably, the temperature analysis module 412 operatively connected to the frequency adjustment module 413, wherein the temperature analysis module 412 is configured to detect and analyze the air temperature in the air frying chamber 10 of the air fryer 1 in a real time manner when the air fryer 1 is operated in the constant temperature heating stage, so as to detect the air temperature change in the air frying chamber 10. The frequency adjustment module 413 is configured to: when the current air temperature increases above the first temperature threshold between the upper limit and the lower limit of the preset target temperature, increase the frequency of the pulse wave, such that the rotation speed of the fan 22 of the air circulation device 20 is adjusted in a stepless manner; and when the current air temperature drops below to the second temperature threshold between the upper limit and the lower limit of the preset target temperature, reduce the frequency of the pulse wave, such that the rotational speed of the fan 22 of the air circulation device 20 adjusted in a stepless manner to maintain the air temperature in the air frying chamber 10 between the upper limit and the lower limit of the preset target temperature.

According to the preferred embodiment, the present invention further comprises an electronic device 60 as shown in FIG. 17, wherein the electronic device 60 comprises one or more processors 61 and a memory 62.

The processor 61 is embodied as a central processing unit (CPU) or other processing units that provide data processing capability and/or program instruction execution capability, wherein the processor 61 can further control other components in the electronic device 60 to perform desired functions.

The memory 62 can be one or more computing program unit which is embodied as a computing-readable storage media, such as volatile memory and/or non-volatile memory. For example, the volatile memory can be random access memory (RAM) and/or cache memory (cache), while the non-volatile memory can be read-only memory (ROM), hard disk, flash memory, or the like. Accordingly, one or more computer program instructions can be stored on the computer-readable storage medium, wherein the processor 61 is able to execute the program instructions, so as to process the methods and/or other desired functions of the present invention.

In one example as shown in FIG. 17, the electronic device 60 further comprises: an input device 63 and an output device 64 operatively connected with each other via a bus system and/or other forms of connection mechanisms.

For example, the input device 63 can be, as an example, a camera module for collecting image data or video data.

The output device 64 is able to output different information, including classification results. The output device 64 can be, as an example, a display, a speaker, a printer, a communication network and a remote output device.

Accordingly, the configuration of the electronic device 60 as shown in FIG. 17 is simplified, wherein other components such as buses, input/output interfaces, etc. are omitted. In addition, for the specific applications, the electronic device 60 can also include any other appropriate components.

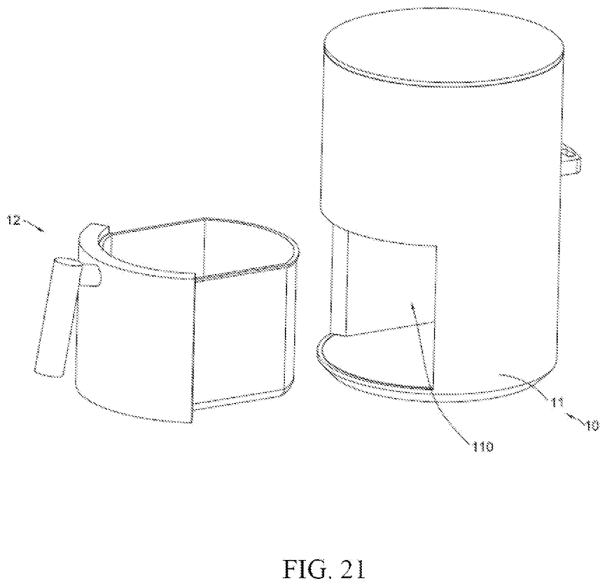

It is worth mentioning that, as shown in FIGS. 18 to 21, the application of the present invention is shown as the air fryer, wherein the air fryer 1 is incorporated with the stepless speed control system 40. In other words, the stepless speed control system 40 is built-in with the air fryer 1 to selectively regulate the air flow rate in the air fryer 1 so as to enhance the air-frying ability of the air fryer 1.

As it is mentioned above, the air fryer 1 has the air frying chamber 10 for receiving the food therein and comprises the air circulation device 20 for circulating air in the air frying chamber 10, and the air heater 30 for heating the air in the air frying chamber 10. The stepless speed control system 40 comprises the signal modulation module 41 and the power adjustment module 42 operatively connected with each other. The signal modulation module 41 is configured to modulate the parameter of the stepless control signal according to the working stage of the air fryer 1. The power adjustment module 42 is configured to adjust the driving power of the air circulation device 20 in a stepless manner in response to the stepless control signal after being modulated, so as to control the air flow rate in the air frying chamber 10. Therefore, after placing the food in the air frying chamber 10, the air is heated by the air heater 30 and circulated by the air circulation device 20 to contact with the food so as to air-fry the food in the air frying chamber 10. At the same time, the stepless speed control system 40 is configured to adjust the air flow rate in the air fryer 1 according to the working stage of the air fryer 1, so as to improve the air-frying ability of the air fryer 1.

It is worth mentioning that the air heater 30 according to the above preferred embodiment can be, but not limited to, an electric heater 31 disposed in the air frying chamber 10 for converting electrical energy into heat energy so as to heat up the air in the air frying chamber 10. In another example, the air heater 30 can be a fluid heat exchanger disposed in the air frying chamber 10 for transferring thermal energy of hot fluid to the air in the air frying chamber 10 so as to heat up the air therein.

Furthermore, the air circulation device 20 according to the above preferred embodiment, as shown in FIGS. 6 and 11, is constructed to have the power supply circuit 21 for operatively connecting with the power source E, the fan 22 electrically connected to the power supply circuit 21, and the speed adjustment device 23 electrically connected to the power supply circuit 21. The speed adjustment device 23 is configured for selectively switching on and off the fan 22 in a real time manner in response to the stepless control signal, so as to control the driving power of the stepless adjustment of the air circulation device 20. It is appreciated that the fan 22 can be incorporated with a DC motor unit or AC motor unit. It is appreciated that the speed adjustment device 23 can be the switching device 231 or the frequency converter 232.

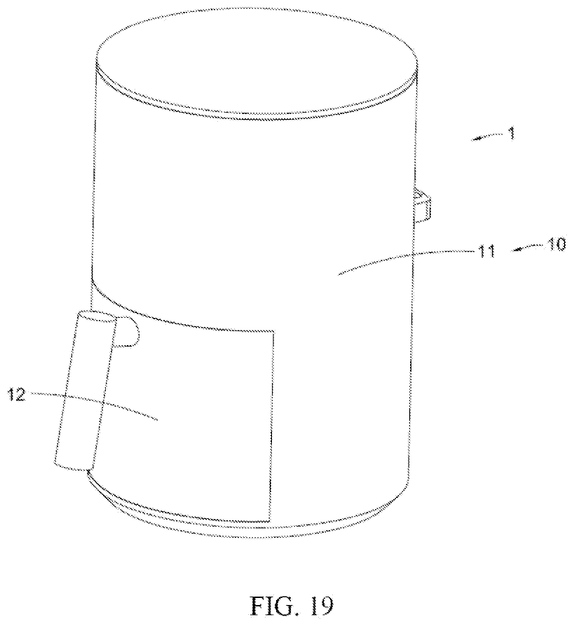

As shown in FIGS. 19 to 21, the air fryer 1 comprises a housing 11 defining an interior cavity 110, and an air frying assembly 12 disposed at the housing 11, wherein the air frying assembly 12 is arranged to retain the food in the air frying chamber 10 which is defined in the internal cavity 110, such that when the air is heated by the air heater 30 and is circulated in the internal cavity 110 by the air circulation device 20, the hot air will contact with the food for air-frying the food.

Preferably, the air frying assembly 12 is detachably coupled to the housing 11 for easily reaching the food in the air frying assembly 12. In one example, the air frying assembly 12 is detachably coupled to the housing 11 by means of, but not limited to, snap fit or lock structure. It is appreciated that the air frying assembly 12 can be, but is not limited to, implemented as a container such as a frying basket with mesh. Likewise, the air frying assembly 13 can incorporate with different components such as rotating grill, skewers and other cooking components, as long as the food can be air-fried in the interior cavity 110 of the housing 11.

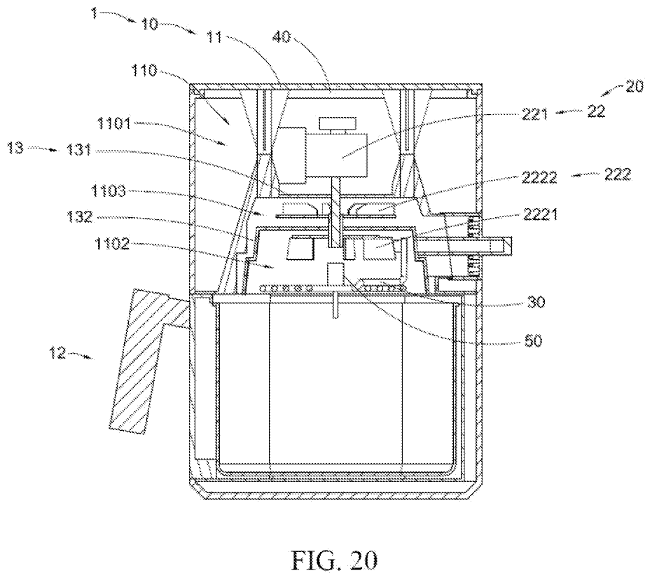

According to the preferred embodiment of the present invention, as shown in FIG. 20, the fan 22 of the air circulation device 20 comprises an electric motor 221 and a fan blade assembly 222 being driven by the electric motor 221 to rotate so as to circulate the air in the air frying chamber 10.

It is worth mentioning that since the temperature of the air is heated by air heater 30, i.e. the hot air, is relatively high, water content of the food will be removed by the hot air so as to form a relative high temperature and humid environment in the air frying chamber 10. As the electric motor 221 of the fan 22 works under such high temperature and humid environment, the service life of the electric motor 221 will be shortened and safety issue is concerned. In order to solve this problem, the air fryer 1 of the present invention further comprises a partition assembly 13 disposed in the housing 11 to divide the interior cavity 110 into an upper compartment 1101 and a lower compartment 1102. The electric motor 221 of the fan 22 is supported at the upper compartment 1101 of the interior cavity 110. The fan blade assembly 222 of the fan 22 further comprises a first fan blade 2221 supported in the lower compartment 1102 of the interior cavity 110 for circulating the air in the lower compartment 1102 when the first fan blade 2221 is drive to rotate by the electric motor 221. Meanwhile, the air frying assembly 12 and the air heater 30 are supported in the lower compartment 1102 of the interior chamber 110 to form the high temperature and humid environment in the lower compartment 1102 of the interior chamber 110. Therefore, the air fryer 1 of the present invention will ensure the air-frying process being completed in the lower compartment 1102 for air-frying the food and will maintain a relatively dry environment in the upper compartment 1101 of the interior cavity 110, so as to prolong the service life span of the electric motor 221 of the fan 22 and to ensure the safety concern of the air fryer 1.

Preferably, the partition assembly 13 comprises an upper partition member 131 and a lower partition member 132 spaced apart from each other, wherein the upper partition member 131 and the lower partition member 132 are disposed in the interior cavity 110 of the housing 11 to form an intermediate compartment 1103 between the upper compartment 1101 and the lower compartment 1102. In other words, the interior cavity 110 of the housing 110 is divided into the upper compartment 1101, the intermediate compartment 1103, and the lower compartment 1102 from top to bottom by the upper partition member 131 and the lower partition member 132. Accordingly, the intermediate compartment 1103 serves as a heat blocking compartment to block the heat from the lower compartment 1102 to the upper compartment 1101, so as to prevent the electric motor 221 of fan 22 being operated in a high temperature environment.

Preferably, the fan blade assembly 222 of the fan 22 further comprises a second fan blade 2222 supported at the intermediate compartment 1103 of the interior cavity 110, wherein the second fan blade 2222 is driven to rotate by the electric motor 211 to generate an air flow in the intermediate compartment 1103 so as to enhance the heat insulation ability of the intermediate compartment 1103. It is appreciated that the first and second fan blades 2221, 2222 are coupled at the same output shaft of the electric motor 221, wherein the second fan blade 2222 is located between the first fan blade 2221 and the electric motor 221. In other words, the first fan blade 2221 is located out of the intermediate compartment 1103, wherein the first fan blade 2221 serves as an outer fan blade while the second fan blade 2222 serves as an inner fan blade.

It is worth mentioning that, according to the first preferred embodiment, the air fryer 1 further comprises a temperature sensor 50 disposed in the air frying chamber 10 and operatively connected to the temperature analysis module 412 of the stepless speed control system 40, wherein the temperature sensor 50 is configured to detect the air temperature in the air frying chamber 10 in a real time manner and to transmit the detected temperature data to the temperature analysis module 412 for analysis. It is appreciated that the temperature sensor 50 can be, but not limited to, a NTC temperature sensor.

Preferably, the temperature sensor 50 is supported in the lower compartment 1102 of the interior chamber 110 of the housing 11, and is located adjacent to the air heater 30, to accurately detect the air temperature in the lower compartment 1102 in a real time manner.

It is worth mentioning that the stepless speed control system 40 of the air fryer of the present invention can be, but not limited to, be implemented as a single-chip microcomputer or a control chip built-in with the air fryer 1 to form an integrated device.

In another example the stepless speed control system 40 can be a control terminal as an external device externally connected to the air fryer 1, such that the air fryer 1 serves as a split device. It is appreciated that the control terminal is operatively connected to the air fryer 1, wherein the air fryer 1 can still be controlled in a stepless manner through the control terminal to provide good air frying ability.

It is worth mentioning that, according to another example of the present invention, the control system 70 is incorporated with the air fryer 1 to control the operation thereof, so as to improve the air frying ability of the air fryer 1.

It is appreciated that the terms “devices”, “equipments”, “systems”, “module” and “unit” in the description and block diagram of the present invention are merely illustrative examples and are not intended to be connected, arranged, and configured in the manner shown in the block diagrams. A person who skilled in the art should will recognize, these devices, equipments, systems, modules and unit can be connected, arranged, and configured in any manner. The terms “include”, “include”, “have”, etc. are open end and mean “including but not limited to” and can be used interchangeably. The terms “or” and “and” as used herein refer to the terms “and/or” and can be used interchangeably, unless the context clearly indicates otherwise. The term “such as” used herein refers to the phrase “such as but not limited to” and can be used interchangeably.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A control method for an air fryer which has an air frying chamber for receiving a food therein and comprises an air circulation device and an air heater, comprising steps of:
(a) controlling an air flow to be circulated in the air frying chamber of the air fryer via a control of the air circulation device;
(b) controlling an air temperature in the air frying chamber via a control of the air heater; and
(c) selectively controlling an air flow rate of the air in the air frying chamber according to a food-related parameter, wherein the air flow rate is selected to match with the food related parameter.

2. The control method as recited in claim 1 wherein, the said food related parameter is decided by the texture of the food, in the step (a), an operating threshold of a driving power of the air circulation device is selectively adjusted according to a moisture content and fat content of the food as the texture thereof, such that a maximum air flow rate in the air frying chamber is direct proportion to the moisture content and the fat content of the food for being air-fried.

3. The method, as recited in claim 2, wherein the step (c) further comprises steps of:
(c.1) identifying the texture of the food to generate a food texture parameter;
(c.2) selecting a preset threshold command from a command list in response to the food texture parameter; and
(c.3) in response to the preset threshold command, selectively adjusting the operating threshold of the driving power of the air circulation device so as to selectively adjust the air flow rate in the air frying chamber in a real time manner not higher than the maximum air flow rate.

4. The control method, as recited in claim 3, wherein the operating threshold of the driving power of the air circulation device is adjusted by modulating a parameter of a stepless control signal within a parameter modulation range.

5. The control method, as recited in claim 2, further comprising steps of:
(d) sequentially operating the air fryer in different working stages which are a preheating stage, a primary heating stage, a constant temperature heating stage and a cooling stage for air frying the food in the air frying chamber;
(e) according to the working stages of the air fryer, controlling the air flow rate in the air frying chamber by a stepless speed control method, wherein the stepless speed control method comprises the steps:
(e.1) according to the working stages of the air fryer, modulating a parameter of a stepless control signal; and
(e.2) in response to the stepless control signal after being modulated, adjusting the driving power of the air circulation device of the air fryer in a stepless manner to control the air flow rate in the air frying chamber.

6. The control method, as recited in claim 2, further comprising a step of:
according to the texture of the food in the air frying chamber, selectively adjusting a maximum air temperature in the air frying chamber to match the air maximum temperature with the food to be air-fried.

7. A stepless speed control method for an air fryer which has an air frying chamber for receiving a food therein and comprises an air circulation device and an air heater, comprising steps of:
(a) sequentially operating the air fryer in different working stages which are a preheating stage, a primary heating stage, a constant temperature heating stage and a cooling stage for air frying the food in the air frying chamber;
(b) according to the working stages of the air fryer, modulating a parameter of a stepless control signal; and
(c) in response to the stepless control signal after being modulated, adjusting the driving power of the air circulation device of the air fryer in a stepless manner to control the air flow rate in the air frying chamber.

8. The stepless speed control method, as recited in claim 7, wherein the stepless control signal is a pulse wave, and the parameter of the stepless control signal includes a duty ratio of the pulse wave.

9. The stepless speed control method as recited in claim 8 wherein the step (c) further comprises steps of:
(c.1) in response to a high electric level of the pulse wave, controllably powering on a power supply circuit of the air circulation device in a real time manner via a switching unit, wherein the current working voltage of a fan of the air circulation device is equal to a real-time voltage applied to the fan through the power supply circuit, such that the fan is operated in a high speed operation stage; and
(c.2) in response to a low electric level of the pulse wave, controllably powering off the power supply circuit of the air circulation device in a real time manner via the switching unit, wherein the current working voltage of the fan is equal to zero, such that the fan is operated in a low speed operation stage.

10. The stepless speed control method as recited in claim 9 wherein the step (b) further comprises steps of:
(b.1) when the air fryer is operated in the preheating stage, adjusting the duty ratio of the pulse wave to zero, such that the driving power of the air circulation device is adjusted to be zero power;
(b.2) when the air fryer is operated in the primary heating stage, adjustably increasing the duty ratio of the pulse wave is set as zero, such that the driving power of the air circulation device is adjusted in a stepless manner;
(b.3) when the air fryer is operated in the constant temperature heating stage, modulating the duty ratio of the pulse wave to adjust the driving power of the air circulation device in a stepless manner; and
(b.4) when the air fryer is operated in the cooling stage, adjusting the duty ratio of the pulse wave to 1, such that the driving power of the air circulation device is adjusted at its full power.

11. The stepless speed control method, as recited in claim 10, wherein the primary heating stage is configured to have a rapid heating stage and a uniform heating stage in a sequence manner, wherein the step (b.2) further comprises steps of:
(b.2.1) when the air fryer is operated in the rapid heating stage, adjusting the duty ratio of the pulse wave to a preset low threshold, such that the driving power of the air circulation device is adjusted to a low power; and
(b.2.2) when the air fryer is operated in the uniform heating stage, adjusting the duty ratio of the pulse wave to 1, such that the driving power of the air circulation device is adjusted to full power.

12. The stepless speed control method, as recited in claim 11, wherein the step (b.3) further comprises a step of:
(b.3.1) when the air fryer is operated in the constant temperature heating stage, adjusting the duty cycle of the pulse wave to a preset high threshold so as to adjust the driving power of the air circulation device to a high power, such that a heat dissipation power of the air fryer is equal to a heating power of the air heater of the air fryer.

13. The stepless speed control method, as recited in claim 11, wherein the step (b.3) further comprises steps of:
(b.3.1) when the air fryer is operated in the constant temperature heating stage, detecting and analyzing the air temperature in the air frying chamber of the air fryer in a real time manner to detect an air temperature change in the air frying chamber;
(b.3.2) when a current air temperature increases above a first temperature threshold between an upper limit and a lower limit of a preset target temperature, increasing the duty ratio of the pulse wave to adjustably increase the driving power of the air circulation device in a stepless manner; and
(b.3.3) when the current air temperature drops below a second temperature threshold between the upper limit and the lower limit of the preset target temperature, decreasing the duty ratio of the pulse wave to adjustably reduce the driving power of the air circulation device in a stepless manner, so as to maintain the air temperature in the air frying chamber between the upper and lower limits of the preset target temperature.

14. The stepless speed control method, as recited in claim 7, wherein the stepless control signal is a pulse wave, and the parameter of the stepless control signal includes a frequency of the pulse wave.

15. The stepless speed control method, as recited in claim 14, wherein the step (c) further comprises a step of:
(c.1) in response to the frequency of the pulse wave, adjusting a frequency of a power supplied to a fan of the air circulation device from a power supply circuit in a real time manner by a frequency converter, so as to controllably adjust a rotational speed of the fan in a stepless manner, such that the driving power of the air circulation device is adjusted in a stepless manner.

16. The stepless speed control method as recited in claim 15 wherein the step (b) further comprises steps of:
(b.1) when the air fryer is operated in the preheating stage, adjusting the frequency of the pulse wave to 0 Hz, such that the fan of the air circulation device stops rotating;
(b.2) when the air fryer is operated in the primary heating stage, adjustably increasing the frequency of the pulse wave, such that the rotational speed of the fan of the air circulation device is adjusted in a stepless manner;
(b.3) when the air fryer is operated in the constant temperature heating stage, modulating the frequency of the pulse wave to adjust the rotational speed of the fan in a stepless manner; and
(b.4) when the air fryer is operated in the cooling stage, controllably adjusting the frequency of the pulse wave to a rated frequency, such that the rotational speed of the fan of the air circulation device is adjusted to the full speed.

17. The stepless speed control method, as recited in claim 16, wherein the step (b.3) further comprises steps of:
(b.3.1) when the air fryer is operated in the constant temperature heating stage, detecting and analyzing the air temperature in the air frying chamber of the air fryer in a real time manner to detect an air temperature change in the air frying chamber;
(b.3.2) when a current air temperature increases above a first temperature threshold between an upper limit and a lower limit of a preset target temperature, increasing the frequency of the pulse wave, such that the rotation speed of the fan of the air circulation device is adjusted in a stepless manner; and
(b.3.3) when the current air temperature drops below to a second temperature threshold between the upper limit and the lower limit of the preset target temperature, reducing the frequency of the pulse wave, such that the rotational speed of the fan of the air circulation device adjusted in a stepless manner to maintain the air temperature in the air frying chamber between the upper limit and the lower limit of the preset target temperature.

18. An air fryer for air-frying a food, comprising:
a housing having an air frying chamber for receiving the food therein;
an air circulation device which comprises a power supply circuit and a fan operatively connected to the power supply circuit for circulating an air flow in the air frying chamber;
an air heater disposed in the housing for heating the air in the air frying chamber;
a control system operatively connected to the air circulation device and the air heater; and
a stepless speed control system which comprises:
a signal modulation module that modulates a parameter of a stepless control signal; and
a power adjustment module that adjusts a driving power of the air circulation device in a stepless manner in response to the stepless control signal after being modulated for controlling an air flow rate in the air frying chamber.

19. The air fryer, as recited in claim 18, wherein the control system operatively connected to the air circulation device and the air heater to sequentially operate the air fryer in different working stages which are a preheating stage, a primary heating stage, a constant temperature heating stage and a cooling stage for air frying the food in the air frying chamber; the parameter of a stepless control signal is according to the working stages of the air fryer; the stepless control signal is a pulse wave, and the parameter of the stepless control signal includes a duty ratio of the pulse wave.

20. The air fryer, as recited in claim 19, wherein the stepless speed control system further comprises a switching unit operatively controlling the power supply circuit of the air circulation device in an on and off manner, wherein the power adjustment module is further configured to:
in response to a high electric level of the pulse wave, controllably power on the power supply circuit of the air circulation device in a real time manner via the switching unit, wherein the current working voltage of a fan of the air circulation device is equal to a real-time voltage applied to the fan through the power supply circuit, such that the fan is operated in a high speed operation stage; and
in response to a low electric level of the pulse wave, controllably power off the power supply circuit of the air circulation device in a real time manner via the switching unit, wherein the current working voltage of the fan is equal to zero, such that the fan is operated in a low speed operation stage.

21. The air fryer, as recited in claim 20, wherein the signal modulation module further comprises a duty ratio adjustment module configured to:
when the air fryer is operated in the preheating stage, adjust the duty ratio of the pulse wave to zero, such that the driving power of the air circulation device is adjusted to be zero power;
when the air fryer is operated in the primary heating stage, adjustably increase the duty ratio of the pulse wave is set as zero, such that the driving power of the air circulation device is adjusted in a stepless manner;
when the air fryer is operated in the constant temperature heating stage, modulate the duty ratio of the pulse wave to adjust the driving power of the air circulation device in a stepless manner; and
when the air fryer is operated in the cooling stage, adjust the duty ratio of the pulse wave to 1, such that the driving power of the air circulation device is adjusted at its full power.

22. The air fryer, as recited in claim 21, wherein the signal modulation module further comprises a temperature analysis module operatively connected to the duty ratio adjustment module:
wherein the temperature analysis module is configured to:
when the air fryer is operated in the constant temperature heating stage, detect and analyze the air temperature in the air frying chamber of the air fryer in a real time manner to detect an air temperature change in the air frying chamber;
wherein the duty ratio adjustment module is further configured to:
when a current air temperature increases above a first temperature threshold between an upper limit and a lower limit of a preset target temperature, increase the duty ratio of the pulse wave to adjustably increase the driving power of the air circulation device in a stepless manner; and
when the current air temperature drops below a second temperature threshold between the upper limit and the lower limit of the preset target temperature, decrease the duty ratio of the pulse wave to adjustably reduce the driving power of the air circulation device in a stepless manner, so as to maintain the air temperature in the air frying chamber between the upper and lower limits of the preset target temperature.

23. The air fryer, as recited in claim 18, wherein the stepless control signal is a pulse wave, and the parameter of the stepless control signal includes a frequency of the pulse wave.

24. The air fryer, as recited in claim 23, wherein the power adjustment module is further configured to:
in response to the frequency of the pulse wave, adjust a frequency of a power supplied to the fan of the air circulation device from the power supply circuit in a real time manner by a frequency converter, so as to controllably adjust a rotational speed of the fan in a stepless manner, such that the driving power of the air circulation device is adjusted in a stepless manner.

25. The air fryer, as recited in claim 24, wherein the signal modulation module further comprises a frequency adjustment module configured to:
when the air fryer is operated in the preheating stage, adjust the frequency of the pulse wave to 0 Hz, such that the fan of the air circulation device stops rotating;
when the air fryer is operated in the primary heating stage, adjustably increase the frequency of the pulse wave, such that the rotational speed of the fan of the air circulation device is adjusted in a stepless manner;
when the air fryer is operated in the constant temperature heating stage, modulate the frequency of the pulse wave to adjust the rotational speed of the fan in a stepless manner; and
when the air fryer is operated in the cooling stage, controllably adjust the frequency of the pulse wave to a rated frequency, such that the rotational speed of the fan of the air circulation device is adjusted to the full speed.

26. The air fryer, as recited in claim 25, wherein the signal modulation module further a temperature analysis module configured to:
when the air fryer is operated in the constant temperature heating stage, detect and analyze the air temperature in the air frying chamber of the air fryer in a real time manner to detect an air temperature change in the air frying chamber;
wherein the frequency adjustment module is configured to:
when a current air temperature increases above a first temperature threshold between an upper limit and a lower limit of a preset target temperature, increase the frequency of the pulse wave, such that the rotation speed of the fan of the air circulation device is adjusted in a stepless manner; and
when the current air temperature drops below to a second temperature threshold between the upper limit and the lower limit of the preset target temperature, reduce the frequency of the pulse wave, such that the rotational speed of the fan of the air circulation device adjusted in a stepless manner to maintain the air temperature in the air frying chamber between the upper limit and the lower limit of the preset target temperature.

27. The air fryer, as recited in claim 18, wherein the control system comprises:
a driver control module operatively controlling the air circulation device for driving the air circulating in an air frying chamber;
a heat control module operatively controlling the air heater for heating the air in the air frying chamber; and
a flow rate control module selectively adjusting the air flow rate in the air frying chamber according to a texture of the food to be air-fried in the air frying chamber, so as to match the air flow rate with the texture of the food.

28. The air fryer, as recited in claim 27, wherein the flow rate control module comprises:
a material recognition module that identifies the texture of the food to be air-fried to obtain a material identification result;
a command instruction module, comprising a command list, wherein the command instruction module selects a preset threshold command from the command list in response to the material recognition result; and
a threshold control module that adjusts an operating threshold of the driving power of the air circulation device to be equal to a predetermined threshold in response to the preset threshold instruction, such that the air flow rate in the air frying chamber is adjusted in a real time manner not higher than a maximum air flow rate.

29. The air fryer, as recited in claim 28, wherein the control system further comprises a temperature control module that selectively adjusts the maximum air temperature in the air frying chamber according to the texture of the food therein, so as to match the maximum air temperature with the food for being air-fried.

30. The air fryer, as recited in claim 18, further comprising an electronic device which comprises:
a processor for executing program instructions; and
a memory that stores the program instructions being executed by the processor to:
control the air circulation device for controlling the air flow to be circulated in the air frying chamber;
control of the air heater for controlling an air temperature in the air frying chamber; and
selectively control an air flow rate of the air in the air frying chamber according to a texture of the food, wherein the air flow rate is selected to match with the texture of the food to be air-fried.
